(19) United States
(12) Patent Application Publication
(10) Pub. No.: US 2016/0132660 A1
(43) Pub. Date: May 12, 2016

(54) ELECTRONIC MEDICATION ADHERENCE, IDENTIFICATION, AND DISPENSATION

(71) Applicant: JANSSEN PHARMACEUTICA NV, Beerse (BE)

(72) Inventors: Veronica BARAJAS, San Diego, CA (US); Francis DEVLIN, Carlsbad, CA (US); Michael IGLESIAS, San Diego, CA (US); Nayanabhiram KALNAD, Buckinghamshire (GB); Christine LIM, Selangor (MY); Gines Diego MIRALLES, La Jolla, CA (US); Taylor ROSENDALE, La Jolla, CA (US); Brett STEWART, San Diego, CA (US); David TRIPI, Goleta, CA (US); Carl S. WASHBURN, San Diego, CA (US); Clarence D. WILHELM, Fremont, CA (US)

(21) Appl. No.: 14/895,895

(22) PCT Filed: Jun. 6, 2014
(86) PCT No.: PCT/US2014/041249

§ 371 Date: Dec. 3, 2015

Related U.S. Application Data
(60) Provisional application No. 61/982,246, filed on Apr. 21, 2014.
(60) Provisional application No. 61/858,560, filed on Jul. 25, 2013.
(60) Provisional application No. 61/858,561, filed on Jul. 25, 2013.
(60) Provisional application No. 61/858,556, filed on Jul. 25, 2013.
(60) Provisional application No. 61/832,040, filed on Jun. 6, 2013.

(51) Int. Cl. G06F 19/00

(52) U.S. Cl. CPC G06F 19/3462; G06F 19/3406

(57) ABSTRACT

An electronic medication system including a network server (112), a patient device (104), and a medication storage device (132) is disclosed. The network server includes a network identification module (164) and a network adherence module (166). The patient device includes a patient adherence module (110) and a pill identification module (152). The medication storage device includes a storage device adherence module (182), a sensor (136), and a storage device display (192). The storage device adherence module is configured to synchronize with the network adherence module and the patient adherence module.

### FIELD

The embodiments discussed herein relate to systems, methods, and apparatus for applications pertaining to medication identification, medication dispensation and patient medication adherence.

### BACKGROUND

Medications—both over the counter and prescription—are a critical component in proper health care. For successful patient treatment, the ability to properly identify and dispense medications, and otherwise insure proper and optimum medication adherence on the part of a given patient, is crucial.

Medication adherence may include a determination of whether and at what rate a patient is taking her scheduled medication, or otherwise adhering to healthcare instructions. Research shows that low medication adherence may result in higher cost of care. For example, studies show that treatment efficacy and health outcomes may be related to or driven by proper medication adherence. In addition, healthcare providers and payers (e.g., insurance entities) use medication adherence as an indicator of healthcare outcomes as well as a tool to assess risk and costs that may be incurred by patients. Accordingly, medication adherence is often used by payers, accountable care organizations, managed care organizations, and healthcare providers as a measure of care quality. Data associated with medication adherence may also be used to determine reimbursement for provided care. For these and other reasons, healthcare providers, patients, and individuals such as family members who support a patient, may want to improve medical adherence.

Currently, medication adherence and data associated therewith, is often measured or based upon claims data. For example, medication adherence can be measured by medication possession ratio (MPR) and/or proportion of days covered (PDC). However, measuring medication adherence based on claims data can be insufficient or problematic. In particular, the medication adherence based on claims data might be generated from prescription refill activity. Accordingly, such data may only reflect medications taken for chronic conditions and the data is typically retrospective.

Measuring medication adherence based on claims data can be inaccurate. For example, measuring medication adherence based on claims data is prone to inflation due to events such as overlapping fills from medication changes and dual-drug therapy. It is also difficult to calculate medication adherence when all refill data for a patient is not available. In addition, persistence of medications can be influenced by non-clinical events such as pharmacy changing, and claims data may not account for a combination of medications to treat a single chronic condition.

The use of multiple medications present unique problems as well, particularly as it relates to accurate medication adherence. Patients and healthcare providers often manage multiple comorbid conditions by prescribing multiple medications. The multiple medications may have asymmetrical dosing schedules, which can lead to missed or improper dosing. The missed or improper dosing can negatively affect a patient and/or contribute to drug-related toxicity. In some circumstances, to assist in the management of multiple medications, some patients or healthcare providers use medication storage devices such as pill boxes. Such medication storage devices are an attempt to organize and schedule multiple medications.

The ability to correctly identify a given medication can also be relevant to proper medication adherence. There are over 175,000 different medications currently available. A significant portion is distributed in the form of pills, tablets, or other portable packages, such as inhaler cartridges. When initially distributed to patients, such medications generally include identifying information. However, many patients remove the prescription medications from their labeled packages to organize (e.g., in pill boxes) or otherwise handle the prescription medications, making identification of a given pill or table—for example—very difficult.

Accurate identification of a medication apart from its packaging can be crucial. Obviously, for there to be proper adherence on the part of the patient, correct identification of a scheduled medication is necessary. Other scenarios requiring proper medication identification are also common. For example, patients with memory or other cognitive problems, or that are illiterate, might require assistance in identifying a given medication. A family member or other assistant who aids a patient may need to identify a medication apart from its packaging. Other contexts requiring proper identification might also apply. For example, a law enforcement or emergency response official might need to identify a medication in the vicinity of an unconscious victim. Likewise, law enforcement officers might need to identify prescription medications that are being sold, used and/or distributed illegally.

The subject matter claimed herein is not limited to embodiments that solve any disadvantages or that operate only in environments such as those described above. Rather, this background is only provided to illustrate example technology areas where some embodiments described herein might be practiced.

### SUMMARY

An example embodiment includes an electronic medication system. The medication system includes a network server, a patient device, and in some configurations a medication storage device. The network server can be implemented with a network identification module and a network adherence module and the patient device can include a patient adherence module and a medication identification module. The optional medication storage device includes a storage device adherence module, a sensor, and a storage device display. The storage device adherence module is configured to synchronize with the network adherence module and the patient adherence module.

Yet another embodiment is directed to a system having a database of identified medications and a processor configured to execute computer instructions to cause a computing system to perform operations for identifying an unidentified medication. The operations include, for example, receiving an image of an unidentified medication from a mobile device via a communication network, extracting identifiable characteristics of the unidentified medication from the image, accessing characteristics of identified medications from the database, comparing the identifiable characteristics of the unidentified medication with characteristics associated with the identified medications in the database, and generating match information indicating the one or more identified medications that the unidentified medication most resembles based on the comparing step. This match information is then communicated to the mobile device, providing, for example, a patient with the identity of the previously unidentified medication.

In another embodiment, a computing device, such as a mobile device, is provided. The computing device includes a camera, a processor and a user interface, as well as instructions stored in memory that are executable by the processor to cause the processor to perform a series of functions. Functions might include generating an image with the camera of an unidentified medication, the image including one or more identifiable characteristics of the unidentified medication, communicating the image and/or the one or more identifiable characteristics via a communication network, receiving match information indicating one or more identified medications that the unidentified medication most resembles based on the one or more identifiable characteristic, and presenting the match information via the user interface. Again, this provides the user of the computing device with the ability to identify a previously unidentified medication.

Still another embodiment is directed to a method of employing a medication storage device to facilitate medication compliance on the part of a patient. Such a method might include the steps of synchronizing a medication storage device with a network adherence module and a patient adherence module of a patient device, where the synchronizing includes receiving a medication schedule associated with the patient using the patient device. In addition, a fill signal indicates one or more medications are loaded in the medication storage device according to the medication schedule. Dose information pertaining to a dose of a medication is displayed, wherein the dose information is at least partially included in the medication schedule. The method also alerts the patient of a scheduled dose ascertains whether, based on a response signal, indicating compliance on the part of the patent.

Another embodiment pertains to a medication storage device. The device includes a display, a processor and instructions stored in memory so as to be executable by the processor to cause the processor to perform certain functions. In an illustrated embodiment, those functions include synchronizing the medication storage device with a network adherence application, the synchronizing including receiving a medication schedule of a patient, receiving a fill signal indicating one or more medications are loaded in the medication storage device according to the medication schedule. Additional functions include displaying on the display dose information of a dose of a medication, the dose information being at least partially included in the medication schedule and then within a particular time interval of a scheduled time of the dose, alerting the patient of the dose. It is then determined whether a medication adherence signal indicating compliance with the dose information is received and if so, recording a medication confirmation signal in response to reception of a medication adherence signal.

Yet another embodiment pertains to a method for assisting a patient to comply with a medication schedule and providing medication adherence data. This embodiment involves the steps of receiving input effective to schedule a dose of a medication including a scheduled time in which the dose of a medication is to be taken by a patient, where the dose of a medication and the scheduled time are included in a medications schedule. Within a predetermined interval of the scheduled time, the patient is alerted that the dose of a medication is to be taken and in response to a response signal indicating the dose of the medication is taken according to the medication schedule, the method calculates data related to medication adherence (adherence data) for the patient.

Other embodiments further enhance a patient's compliance with a medication schedule by involving a third party monitor or sponsor. For example, in one embodiment a method is provided for monitoring medication adherence, including the steps of enabling the creation of a medication schedule including a scheduled time in which a dose of a medication is to be administered and enabling the selection of a monitor or sponsor. Within a predetermined interval of a scheduled time, the method enables the generation of a response signal indicating the dose of a medication associated with a scheduled time was administered, and a monitor alert trigger configured to prompt generation of a monitor alert based on the response signal is provided. In the event of a monitor alert trigger (i.e., which might indicate that a patient has missed a dosage), a monitor alert is communicated to the monitor, who then might, for example, intervene and insure that the patient complies with the medication schedule.

Compliance might also be enhanced by providing incentives to a patient. For example, in one embodiment a patient is rewarded with contributions to an entity such as a charity if he or she complies with a medication plan. This embodiment includes enabling selection of an entity to receive a donation, determining whether a dose of a medication was administered to a patient in accordance with a medication schedule and, if so, facilitating a donation to the selected entity (such as a charity).

Still other embodiments contemplate the use of a mobile device to insure compliance on the part of a patient. For example, in one example embodiment a mobile device includes a processor configured to execute computer instructions to cause a computing system to perform operations for calculating data related to medication adherence (adherence data). The operations include enabling creation of a medication schedule including scheduled times in which doses of one or more medications are to be administered to a patient, within a predetermined interval of a scheduled time, alerting the patient that a dose of a medication is to be administered—for example via an audible or visual alert—and then presenting an icon to the patient. The patient interacts with the icon, which is configured to generate a response signal indicating the dose was administered according to the medication schedule. Receiving the response signal indicates that the dose of the medication was properly and timely administered. Adherence data, based at least in part on the response signal, is then calculated for that patient.

Some or all of the foregoing embodiments might be implemented within an an electronic medication system. Such a system might include a patient device, a network server and a medication storage device. The patient device includes a patient adherence module and a medication identification module, wherein the medication identification module is configured to generate an image of an unidentified medication having one or more identifiable characteristics, communicate the image and/or the one or more identifiable characteristics via a network, and receive the identity of the unidentified medication based on the one or more identifiable characteristics. The patient adherence module is configured to receive input effective to schedule doses of one or more medications including scheduled times in which the doses are to be administered to a patient, the scheduled doses of the one or more medications being included in a medications schedule, alert the patient that a dose of a medication is to be taken, and calculate data related to medication adherence (adherence data) based on confirmation that the dose is administered according to the medication schedule. The network server includes a database of identified medications, a network identification module, and a network adherence module, wherein the network identification module is configured to compare an image and/or identifiable characteristics of an unidentified medication from the patient device with a database of identified medications so as to identify the unidentified medication and communicate the identity of the medication to the patient device. The medication storage device includes a storage device adherence module, a sensor and a storage device display, wherein the storage device adherence module is configured to synchronize with the network adherence module and the patient adherence module, the synchronizing including receiving the medication schedule; receiving a fill signal indicating one or more medications are loaded according to the medication schedule; locally display on a storage device display dose information pertaining to a dose of a medication; within a particular time interval of a scheduled time of the dose, alert the patient of the dose; and determine whether a response signal indicating compliance with the dose information is received. This overall system provides a comprehensive solution to insuring compliance on the part of a patient to a medication schedule.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example electronic medication system (medication system);

FIG. 2 illustrates a block diagram of an example embodiment of a computing device that may be implemented in the medication system of FIG. 1;

FIGS. 3A and 3B illustrate block diagrams of an example storage device that may be implemented in the medication system of FIG. 1;

FIG. 4 illustrates an example server that may be implemented in the medication system of FIG. 1;

FIG. 5 illustrates an example image of a pill with identifiable characteristics;

FIGS. 6A and 6B illustrate an example of a patient device progressing through an example series of steps representative of a patient experience with the medication system of FIG. 1;

FIG. 7 is a flow diagram of an example method of identifying pills;

FIG. 8 is a flow diagram of another example method of identifying pills;

FIG. 9 is flow diagrams of an example method of employing a medication storage device to facilitate medication compliance of a patient;

FIGS. 10A and 10B are a flow diagram of an example method of medication adherence measurement, all in accordance with at least one embodiment described herein.

### DESCRIPTION OF SOME EXAMPLE EMBODIMENTS

Healthcare providers, patients, and those who support patients have an interest in improving patient care, reducing costs associated with that patient care, and improving outcomes of the patient care. Medications play an increasingly significant role in this regard. Consequently, the number of medications generally available and prescribed to patients is increasing. One way of achieving improved care, reducing costs, and improving outcomes is through measuring and encouraging proper medication adherence on the part of a patient for whom the medication has been prescribed. Accordingly, embodiments disclosed herein generally relate to systems and methods that assist, improve and encourage proper medication adherence on the part of patients.

For example, some embodiments relate to medication adherence calculations. In an example embodiment, a programmable device, such as a mobile device (e.g., a “smartphone” or the like), includes a processor configured to execute computer instructions to control a performance of one or more operations for calculating a medication adherence rate. As will be described in further detail, the operations may include providing a user interface to patients and/or healthcare providers that may be used to create and display a medication schedule in which doses of medications and scheduled times for each of the doses of the medications can be tracked. For example, within a predetermined interval of a scheduled time, a patient may receive an alert reminding her to take the dose of a subject medication. Following the alert, an icon may be presented to the patient that enables her to generate a compliance response signal. This response signal indicates that the patient took the dose of the medication. Completion of a given dosage may then be used to calculate one aspect of the medication adherence rate by the patient.

In some embodiments, operations may be included that encourage the medication adherence on the part of the patient. For example, it has been observed that by objectively monitoring an individual's performance of a task, the performance quality of that individual with respect to the task, including adherence, may improve. This observed phenomenon is sometimes referred to as the “Hawthorne Effect.” The Hawthorne Effect may be applied in the context of treatment and care of a medical patient. For instance, some embodiments allow a patient to select a sponsor, otherwise referred to as a monitor or monitoring entity. The sponsor or monitor may include a family member or a friend. The patient's performance with respect to compliance with a medication schedule can be improved by notifying the monitor via monitor alerts that are generated when the patient has failed to comply with a medications schedule. These embodiments rely on the so-called Hawthorne Effect to improve the patient's adherence and performance of a dosage regime.

Likewise, in fitness and exercise, fundraising for charities has been observed as an effective incentive for participants. For instance, a charity might calculate a donation amount in relation to the number of miles that are run or biked by a participant or group of participants. Accumulation of miles on the part of a participant is both incentivized and rewarded by such a program. Some embodiments described herein include operations that incentivizing a patient's compliance with a medication schedule by donating to a charity (or other reward mechanism) selected by the patient. Such rewards may thereby incentivize the patient's adherence to a medication dosage schedule.

Other techniques for insuring and promoting medication adherence are provided. For example, in some embodiments the programmable device may be paired with a medication storage device (storage device) that physically retains a patient's medications. The storage device includes electronics so as to perform one or more operations to facilitate medication adherence on the part of the patient. In one embodiment, the storage device includes wireless communication capabilities that enable the storage device to periodically synchronize with the programmable device and/or other applications within a network. Synchronization might include, for example, receiving a medication schedule for a patient. The storage device might also include an electronic display for displaying information relating to medications and related dosage schedules for the patient. For example, such information might include a graphical image of a medication(s) for which a dosage is scheduled, thereby assisting the patient in selection of the proper medication; this can be particularly helpful if multiple medications are stored in the storage device. Additionally, visual and/or audible alerts might be communicated by the storage device to the patient indicating, for example, a scheduled time of a dose and/or which of multiple storage bays the medication is stored. In some embodiments, the storage device might include additional functionality so as to detect whether a patient has actually retrieved and (presumptively) administered a dose. For instance, a bay sensor, which is triggered by the patient opening a bay of the storage device, can be used to indicate that the patient has opened the bay containing the dose.

Other functionality might also be provided—either alone or in conjunction with other techniques—to enhance medication adherence on the part of a patient. For example, the programmable device can be configured to further assist in the identification of a given medication, such as a pill, tablet or other delivery mechanism. In these embodiments the programmable device, such as a smartphone, captures an image of an unidentified medication (such as a pill, tablet or other medication container or delivery mechanism) and communicate the image to a network server. The network server can then identify the medication. For example, if the unidentified medication is a pill or tablet, the identification can occur based on a comparison between the image and a database of pill/table images. The network server may then communicate match information to the smartphone. In these embodiments, patients may avoid taking unidentified pills and/or properly handle pills that have become disassociated with a container including identifying information, further enhancing the patient's compliance with a given dosage schedule.

These and other embodiments are described herein with reference to the appended figures. In the figures, like structures will be provided with like reference designations. The figures are diagrammatic and schematic representations of some embodiments, are not limiting, nor are they necessarily drawn to scale.

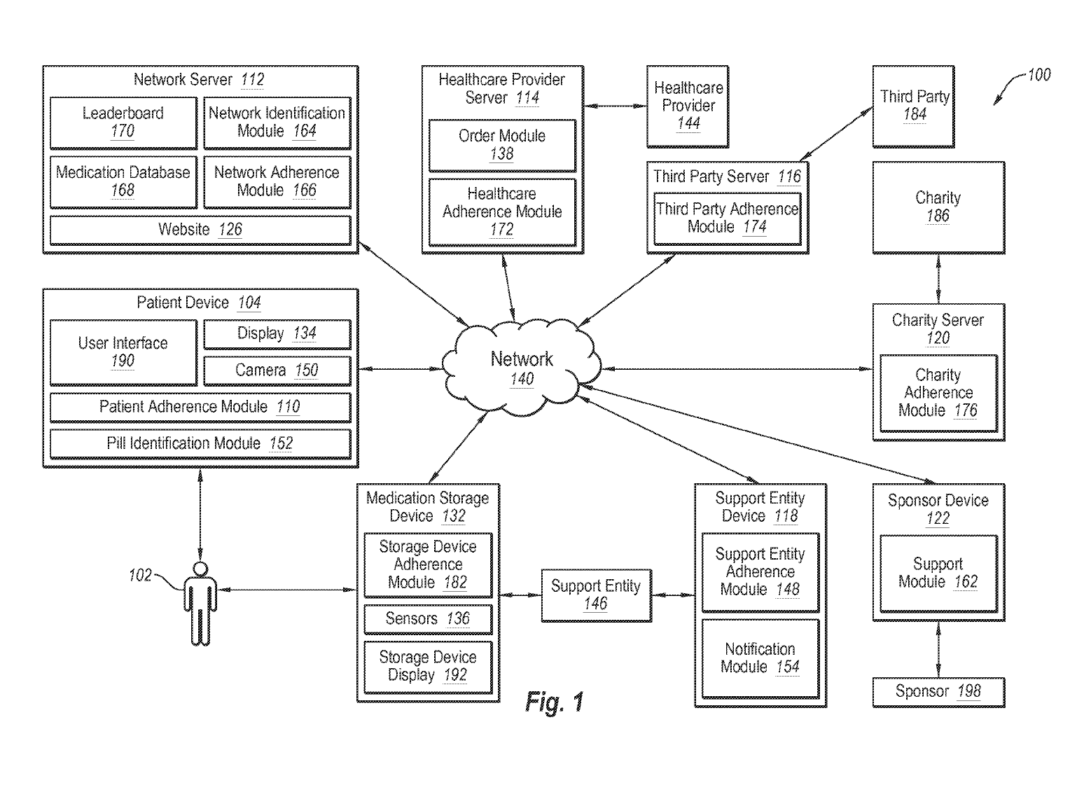

FIG. 1 illustrates an example electronic medication system (medication system), denoted generally at 100. The medication system 100 is implemented to encourage, facilitate, and measure medication adherence on the part of a patient 102. In the illustrated embodiment, the medication system 100 of FIG. 1 includes a network server 112, a patient device 104, a medication storage device (storage device) 132, a support entity device 118, a sponsor device 122, a charity server 120, a third party server 116, and a healthcare provider server 114 (collectively, referred to as medication system components). The medication system components may be configured to communicate via a network 140. For example, the medication system components may be configured to communicate data and information pertaining to mediation adherence, medication dispensation, and medication identification via the network 140.

The network 140 may be wired or wireless, or a combination of the two, and might be configured by way of a number of configurations and topologies including a star configuration, a token ring configuration, or another suitable configuration. Furthermore, the network 140 may include a local area network (LAN), a wide area network (WAN) (e.g., the Internet), and/or other interconnected data paths across which multiple devices may communicate. In some embodiments, the network 140 may include a peer-to-peer network. The network 140 may also be coupled to or include portions of a telecommunications network that may enable communication of data in a variety of different communication protocols. In some embodiments, the network 140 includes BLUETOOTH® communication networks and/or cellular communications networks for sending and receiving data including via short messaging service (SMS), multimedia messaging service (MMS), hypertext transfer protocol (HTTP), direct data connection, wireless application protocol (WAP), email, etc.

One or more of the patent device 104, the support device 118, and the sponsor device 122 may include a computing device that include a processor, a memory, and network communication capabilities. The communication capabilities may include wireless fidelity (Wi-Fi), BLUETOOTH®, 3G, 4G, LTE communication networking capabilities, or any combination thereof. For example, the patient device 104, the support entity device 118, and the sponsor device 122 may be configured to communicate to one or more other of the medication system components via the network 140. Some examples of the patient device 104, the support entity device 118, and the sponsor device 122 may include a laptop computer, a desktop computer, a tablet computer, a mobile telephone, a personal digital assistant (PDA), a mobile email device, a portable game player, a portable music player, a television with one or more processors embedded therein or coupled thereto or other electronic device capable of accessing the network 140.

The patient device 104 may be associated with the patient 102, who may include an individual receiving treatment and otherwise interacting within the medication system 100. The term “associated with” as used to describe a relationship between the patient 102 and the patient device 104 and similar relationships described herein may indicate that the patient device 104 may be owned and/or routinely operated by the patient 102. Accordingly input received at the patient device 104 may be attributed to the patient 102 and information sent to the patient device 104 may be intended for the patient 102.

The patient device 104 may include a user interface 190, a display 134, a camera 150, a patient adherence module 110, and a medication identification module (pill ID module) 152. The user interface 190 may include an audio interface such as a microphone and speaker, a keyboard, a mouse, touchscreen, another suitable user interface, and may be include or be otherwise incorporated with the display 134.

The display 134 can be implemented as a light-emitting diode (LED) display, an organic LED (OLED), a touchscreen (e.g., resistive, surface acoustic wave, capacitance, infrared grid, etc.), or any other suitable display. The display 134 may be integrated with the user interface 190 and communicatively coupled to the processor and/or the memory of the patient device 104. Images and data stored in the memory can be displayed on the display 134. Additionally, the processor may control the display of images and data on the display 134.

For example, the user interface 190 and the display 134 may be configured to present information and data to the patient 102 and receive input from the patient 102. For instance, alerts indicating that a dose of a medication is due may be presented to the patient 102. The alerts may include a chime and displayed dose information. The alerts may be communicated to the patient 102 via the user interface 190 and the display 134. In particular, an audio interface may generate the chime and the dose information may be displayed on the display 134. Additionally, patient input such as pressing an icon on the display 134 may be received and communicated to the processor.

The camera 150 may include any device capable of generating an image. In some embodiments, the camera 150 may be configured to capture (e.g., to take a photograph or video) an image of a pill. The camera 150 may accordingly include a still photo camera, a video camera, and the like. In some embodiments, the camera 150 may be the primary feature of the patient device 104. For example, the patient device 104 may be a digital still camera that includes networking capabilities. In some embodiments, the camera 150 may be a supplementary device of the patient device 104. For instance, the patient device 104 may be a mobile smartphone and the camera 150 may be incorporated in the mobile smart phone.

The patient adherence module 110 may be configured to calculate, track, and communicate information and data related to medication adherence of the patient 102. For example, based on a medications schedule, the patient adherence module 110 may alert the patient 102 when doses of medications are to be administered or taken. Additionally, based on input received from the patient 102, the patient adherence module 110 may calculate data related to medication adherence (adherence data) of the patient 110 and additionally data derived from the adherence data (generally, additional data). The patient adherence module 110 may then communicate portions of the adherence data throughout the medication system 100.

For example, the adherence data or additional data may be used as a basis for charitable donations to a charity 186 (or similar type of incentive model). Additionally or alternatively, the adherence data or additional data may trigger monitor alerts that are communicated (along with the adherence data in some embodiments) to the support entity 146. Some additional details of the patient adherence module 110 are provided elsewhere herein.

The pill ID module 152 may be configured to enable identification of medications. In particular, the pill ID module 152 may enable identification of unidentified tablets, pills or related medication “containers” based on images of the unidentified medications, for example (in this respect, the term “pill” is used generically to refer to different medications that might require identification). For example, the pill ID module 152 receives images of unidentified pill(s) from the camera 150 and communicates the images to the network server 112 where a match of the unidentified pills can be found. The match information along with some additional information can then be presented to the patient 102 via the display 134 and/or the user interface 190. Some additional details of the pill ID module 152 are provided elsewhere herein.

The support entity device 118 may be associated with the support entity 146. Thus, communication of information to the support entity device 118 may be intended for the support entity 146 and information communicated from the support entity device 118 may be attributed to the support entity 146.

The support entity 146 may be one or more individuals that are permitted to have access to data related to the patient 102. The support entity 146 might have a relationship with the patient 102 so as to influence the actions of the patient 102. Some examples of the support entity 146 are a family member, a spouse, a sponsor, a friend, a partner, or another trusted or influential individual. In some circumstances, the support entity 146 might be selected or invited by the patient 102 and/or by a healthcare provider 144. Additionally, the support entity 146 may initiate a request in connection with the patient 102.

The support entity device 118 may include a support entity adherence module 148 and a notification module 154. The support entity adherence module 148 may be configured to interface with the patient adherence module 110 as well as other modules (e.g., 166, 172, 174, and 176) and medication system components to communicate data and information related to medication adherence of the patient 102. For example, the support entity adherence module 148 may enable the support entity 146 to provide information such as reminders to the patient 102 via the patient adherence module 110. Additionally, an alert communicated to the patient adherence module 110 may also be communicated to the support entity adherence module 148.

The notification module 154 may be configured to receive monitor alerts from one or more of the medication system components. For example, the patient 102 may select the support entity 146 as a monitor. Based on medication adherence of the patient 102, the patient adherence module 110 may communicate a monitor alert to the notification module 154 of the support entity device 118.

The sponsor device 122 may be associated with a sponsor 198. The sponsor 198 may include any entity having an interest in the treatment of the patient 102 (by virtue of compliance) and/or an interest in supporting the charity 186. An example sponsor 198 may include an individual having a relationship with the patient 102 such as a family member or an employer, or may be an entity otherwise having an interest in patient success, such as an insurance company or healthcare provider. The sponsor 198 may offer to sponsor donations to the charity 186 or may be solicited by the patient 102, the charity 186, the healthcare provider 144, or another entity to sponsor donations to the charity 186.

The sponsor device 122 may include a support module 162 configured to make a donations based a particular level of medication adherence. For example, the support module 162 may receive message indicating the patient 102 has obtained a particular level of medication adherence. In response, the support module 162 may enable the transfer or transfer funds to the charity 186.

In some embodiments, the sponsor device 122 may include a hardware server or another suitable computing device. Additionally or alternatively the sponsor device 122 may be owned or operated by a financial institution, which may make the donations on behalf of the sponsor 198.

One or more of the network sever 112, the healthcare provider server 114, the third party server 116, and the charity server 120 may include a hardware server that further includes a processor, memory, and communication capabilities. In the illustrated embodiment, the one or more of the network sever 112, the healthcare provider server 114, the third party server 116, and the charity server 120 may be coupled to the network 140 to send and receive data to and from one or more of the medication system components.

The network server 112 may include a network identification module (network ID module) 164, a network adherence module 166, and a medication database 168. The network ID module 164 may be configured to receive images of unidentified pills from the pill ID module 152. The network ID module 164 may identify the pill from the image based on information stored in the medication database 168. For example, the medication database 168 may store images and other characteristics of identified pills. The other characteristics may include size, dimensions, color, shape, volume, weight, distribution records, and the like. The image of the identified pills may include one or more of the characteristics, which may enable a match between an identified pill in the medications database and the unidentified pill in the image. In response, the network ID module 164 may communicate the match information to the pill ID module 152. In some embodiments additional information related to the match may also be communicated to the pill ID module 152.

In the medication system 100, the pill ID module 152 is included in the patient device 104 and the network ID module 164 is included in the network server 112. In some embodiments, both the pill ID module 152 and the network ID module 164 may be included in the patient device 104 or one or more functions described with reference to the network ID module 164 may be performed by the pill ID module 152 and vice versa. The network adherence module 166 may be configured to receive data and information related to medication adherence of the patient 102. Additionally, the network adherence module 166 may communicate information and data related to medication adherence to the patient device 104, the medication storage device 132, or another medication system component.

In some embodiments, calculation of adherence data may be performed by the network adherence module 166. Additionally or alternatively, the additional data derived from the adherence data may be calculated by the network adherence module 166. Additionally, one or more of the functions such as generation/communication of monitor alerts and messages related to donations may be performed by the network adherence module 166. The network server 112 may also host a website 126. The website 126 may enable access by one or more other medication system components to information on the network server 112. For example, in some embodiments, the website 126 may provide an interface via which adherence data and/or pill identification data may be communicated to and from the network server 112. Specifically, the network server 112 allows access to the website 126 using an application such as a web browser application.

The network adherence module 166 and/or the network ID module 164 may be configured to determine content on the website 126 and/or provide to the patient 102 or the support entity 146 a user interface through which the patient 102 or the support entity 146 may interface with the network adherence module 166 and/or the network ID module 164. For example, the network adherence module 166 may allow the support entity 146 to view a medication schedule or adherence data of the patient 102.

The network adherence module 166 and/or the network ID module 164 may additionally enable synchronization of data among the medication system components. Thus, during synchronization, information and data may be accessed from the network server 112 and communicated to the network server 112.

In some embodiments, the network server 112 may host a leaderboard 170. Donations or donation records (or similar incentive mechanisms) might be published to the leaderboard 170 via the network 140. The leaderboard 170 might be virtually implemented via a public, semi-public, or private webpage or website (e.g., the website 126) on which information may be posted or published. The leaderboard 170 can be configured such that the donations records of the patient 102 along with one or more other patients are published. Once published, the patients, the charity 186 of each of the patients, the healthcare provider 144 of the patients, the sponsor 198, the patient 102, other individuals, or any combination thereof can view the results, which can be provided/updated in substantially real time. The leaderboard 170 might thereby provide a level of accountability and/or competition among the patients, further incentivizing or encouraging participation and success.

In some embodiments, donation records of the patients may be consolidated over a period of time or with respect to the charity 186, for instance. The consolidated donation records can be published to the leaderboard 170. The patient 102 can be ranked or otherwise categorized with respect to other patients according to the donation records and/or adherence statistics on the leaderboard 170.

In embodiments in which the leaderboard 170 is included, identifying information of the patient 102 may obscured to protect the privacy of the patient 102. Moreover, the participation in the leaderboard 170 may be limited to activities that may not introduce privacy concerns.

The healthcare provider server 114 may be associated with the healthcare provider 144. The healthcare provider 144 may include individuals and/or organizations that may be interested in the treatment of the patient 102. The healthcare provider 144 may be involved with or associated with the support entity 146 and the patient 102 such that information may be shared therebetween. Additionally, the healthcare provider 144 may be selected or invited by the patient 102 or the support entity 146 to receive one or more of the monitor alerts and/or adherence data as described herein.

The healthcare provider server 114 may include an order module 138 and a healthcare adherence module 172. The order module 138 and/or a healthcare adherence module 172 may be configured to communicate data and information related to medication adherence. For example, the order module 138 may receive data indicating that a refill of a prescription of the patient 102 is due. In response, the order module 138 may prepare to refill the prescription. Additionally or alternatively, the healthcare adherence module 172 may be configured to enable the healthcare provider 144 to interact (e.g., sent messages and the like) to patient adherence module 110 and/or the patient device 104. The healthcare adherence module 172 may also receive alerts and/or notifications based on medication adherence of the patient 102.

The third party server 116 may be associated with the third party 184. In some embodiments, the third party 184 might include a healthcare payer, a governmental organization, a healthcare provider, an insurance company, a data processing company, or the like.

The third party server 116 may include a third party adherence module 174. The third party adherence module 174 may be configured to interface with one or more of the patient adherence module 110, the storage device adherence module 182, the network adherence module 166, etc. included in the medication system 100. Adherence data and additional data derived therefrom may be communicated to the third party adherence module 174. For example, the information communicated in the medication system 100 can be used by the third party 184 to set or modify insurance premiums (e.g., increasing insurance premiums based on adherence data indicating the patient fails to take medication). The third party 184 may then communicate the modified insurance premium to the healthcare provider 144, the support entity 146, the patient device 104, or any combination thereof.

The charity server 120 may be associated with the charity 186. The charity 186 may include any individual and/or any charitable organization, without limitation. The charity 186 may be selected or invited by the patient 102 or the healthcare provider 144. Additionally, the charity 186 may request to be the charity 186 of the patient 102.

The charity server 120 may include a charity adherence module 176. The charity adherence module 176 may be configured to communicate data and information related to medication adherence of the patient 102. For example, the charity adherence module 176 may receive an indication that the patient 102 achieves a target level of medication adherence. In response, the charity adherence module 176 may communicate a signal to the support module 162 to transfer funds to the charity 186. Additionally or alternatively, in response the charity adherence module 176 may track funds owed to the charity 186.

The storage device 132 may be associated with the patient 102. Accordingly, medication schedules communicated to the storage device 132 are intended for the patient 102. Additionally, signals generated/communicated by the storage device 132 are attributed to the patient 102. The storage device 132 may include a computing device implemented with a storage structure. The storage device 132 may include a processor, a memory, and network communication capabilities. For example, the storage device 132 may be configured to communicate information and data to the medication system components via the network 140.

Some examples of the storage device 132 may include a “pill box.” In these and other embodiments, the storage device 132 may include one or more bays, trays, slots, or similar physical storage locations. The bays may be unlabeled or may be designated according to a day of the week, a day in a month, AM/PM, time, a medication type, a method of administration, or any combination thereof. The storage device 132 and/or the bays included in the storage device 132 may include lights, vibration devices, audio transmitters, etc. configured to alert the patient 102 to a particular bay or generally to the storage device 132. The storage device 132 and/or the bays may have a generally rectangular shape, circular shape, oval shape, or any other suitable shape for accommodating a particular medication, whether in pill or tablet form or otherwise.

The storage device 132 may include a storage device display 192. The storage device display 192 can be implemented as a light-emitting diode (LED) display, an organic LED (OLED), a touchscreen (e.g., resistive, surface acoustic wave, capacitance, infrared grid, etc.), or any other suitable display. The storage device display 192 is communicatively coupled to the processor and/or the memory. Images and data stored in the memory can be displayed on the storage device display 192. Additionally, the processor controls the display of images and data on the storage device display 192.

Additionally, the storage device 132 may include one or more sensors 136. The sensors 136 may be used to measure various conditions of the storage device 132, the patient 102, and/or other users (e.g., the support entity 146) who may interact with the storage device 132. The sensors 136 can be communicatively coupled to the processor and/or the memory. For example, the processor might receive a signal indicating a condition measured by one or more of the sensors 136 and perform an action based thereon (e.g., communicate the signal, or information pertaining to the signal, to the storage device display 192). Additionally, the memory may receive a signal indicating a condition measured by one or more of the sensors 136 and store the signal and/or representative information.

An example of the sensors 136 may include a physiological sensor. The physiological sensor may be used to measure a physiological state of the patient 102. The processor may receive the measurement of the physiological state and generate dose information for a medication related to the physiological state. For example, a physiological sensor might be implemented as a glucose measurement device. The physiological sensor may communicate blood glucose levels to the processor, which may then determine a proper amount of a dose of insulin for the patient 102. The proper amount of the dose of insulin may be displayed on the storage device display 192, in some embodiments.

Another example of the sensors 136 may include a bay access sensor. The bay access sensor may be implemented to detect whether the patient 102 has accessed a bay (or otherwise retrieved a medication placed in the bay) included in the storage device 132. For example, the storage device 132 may include a first magnetic door sensor positioned on a first bay door. In response to the patient 102 opening the bay door, a signal may be communicated from the first magnetic door sensor to the processor indicating the patient 102 has accessed a first bay. Some other bay door sensors may include light sensors, touch (capacitive, resistive, or similar) sensors, hinge position sensors, rotational sensors, pressure sensors, clock sensors, accelerometers, and the like.

Another example of the sensors 136 is a biometric reader. The biometric reader may measure a unique characteristic of the patient 102 or the support entity 146, who may be granted access to the storage device 132. The biometric reader may communicate a measurement of the unique characteristic to the processor. Based on the measurement of the unique characteristic, the processor may perform or control the performance of an action. For example, the biometric reader may include a fingerprint analyzer. The patient 102 or the support entity 146 may press her finger against the fingerprint analyzer. An image and/or one or more parameters of a fingerprint may be communicated to the processor. If the fingerprint measured by the fingerprint analyzer is verified as that of the patient 102 or the support entity 146, then the processor may perform an action such as unlocking the storage device 132 or displaying certain dose information pertaining to the patient 102 or the support entity 146.

Another example of the sensors 136 may include a fill sensor. The fill sensor generates a fill signal when the storage device 132 is loaded with medications. For example, dose information of multiple medications may be included in a medication schedule. The dose information may be displayed on the storage device display 192 or the display 134 of the patient device 104. The patient 102 may load the storage device 132 according to the dose information included in the medication schedule. The patient 102 may then actuate or trigger the fill sensor, which may generate a fill signal indicating the storage device 132 has been loaded. Some examples of the fill sensor may include a button, a switch, or another user interface that may be actuated by the patient 102 or another individual (e.g., the support entity 146).

The storage device 132 may include a storage device adherence module 182. The storage device adherence module 182 may be configured to communicate with the patient adherence module 110 and/or the network adherence module 166. For example, the storage device adherence module 182 may be configured to receive a medications schedule. Signals may be communicated to the storage device 132 and the patient device 104 to alert the patient 102 that a dose is due. Additionally, graphical representations of the pill may be presented on the storage device display 192 and/or the display 134 (of the patient device 104) to assist the patient in selection of the proper medication. Moreover, a bay sensor corresponding to the bay in which the medication is located may illuminate and/or vibrate. Some additional details of the storage device adherence module 182 are provided elsewhere herein.

In the medication system 100 multiple interrelated operations may be performed that involve one or more of the medication system components and modules included therein. The medication system 100 of FIG. 1 may include one or more of a medication identification subsystem (medication ID subsystem), a medication adherence subsystem, a medication adherence monitoring subsystem, a charitable contribution subsystem, and a medication dispensation subsystem. Each of the subsystems may perform a set of operations related to the patient 102. For example, the medication ID subsystem may enable identification of medication and communication of the identification to one or more of the patient 102, the third party 184, the healthcare provider 144, and the support entity 146. The medication adherence subsystem may enable tracking and otherwise quantifying medication adherence of the patient 102. The medication adherence monitoring subsystem may enable the support entity 146 to monitor the medication adherence of the patent 102. The charitable contribution subsystem may provide an incentive to the patient 102 for medication adherence, namely the charitable contribution system may make charitable contributions to the charity 186 on behalf of the patient 102. The medication dispensation subsystem may facilitate dispensation of one or more medications to the patient 102. Some details of each of the subsystems included in the medication system 100 are provided below.

Medication ID Subsystem

The medication system 100 of FIG. 1 may include the medication ID subsystem. The medication ID subsystem may include the network server 112 and the patient device 104, or another similar computing device including the pill ID module 152. By connecting the patient device 104 with the network server 112, image capabilities and processing capabilities of the patient device 104 may be expanded to include processing power and storage capabilities of the network server 112. More specifically, the medication ID subsystem may enable identification of an unidentified pill using a processor of the network server 112 that may have access to the medication database 168 that stores information pertaining to identified pills. As used herein, the term “pill” is used in a generic sense to refer to identifiable medications, including pills, capsules, tablets, and the like.

The pill ID module 152 generally enables the patient 102 or another individual to photograph or otherwise generate or acquire an image of an unidentified pill. The image of the unidentified pill may include one or more identifiable characteristics.

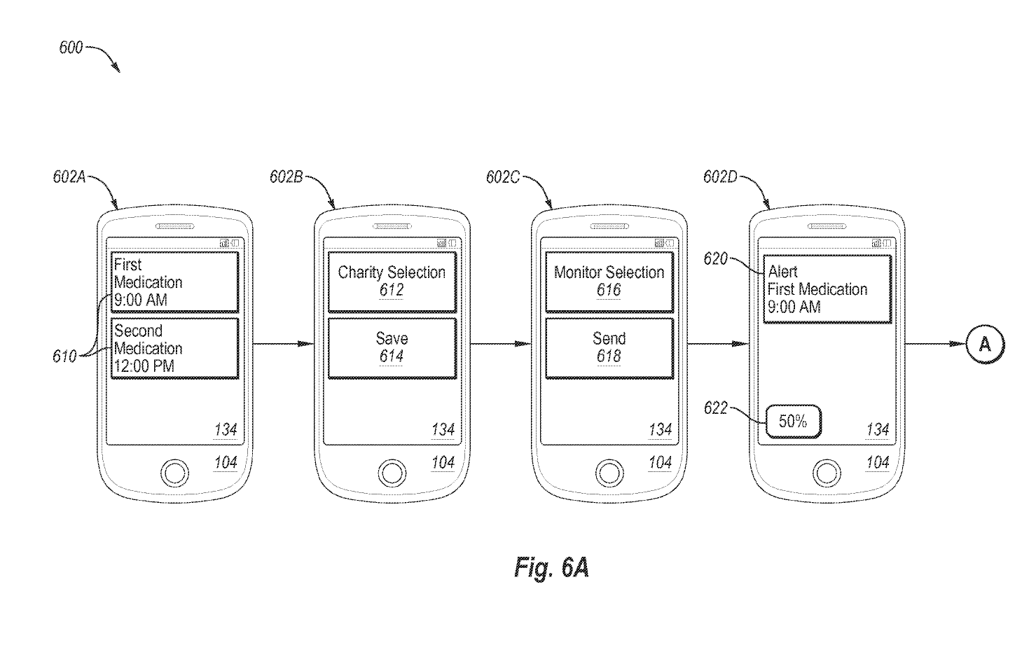

For example, with reference to FIG. 5, an example image 500 of a pill 504 with identifiable characteristics is illustrated. The image 500 includes multiple identifiable characteristics. Example identifiable characteristics may include a shape of the pill 504, which may be indicated in FIG. 5 by a dashed line 502 surrounding the pill 504. The shape of the pill 504 may be a two-dimensional shape as illustrated in FIG. 5 or may include one or more three-dimensional aspects of the pill 504. Additionally or alternatively, an example identifiable characteristic may include a height/width ratio, which may include the ratio of a first dimension 506 to a second dimension 508. Additionally or alternatively, an example identifiable characteristic may include a geometry of the pill 504, which may include the dashed line 502 surrounding the pill 504 along with a three-dimensional aspect indicated by dashed lines 510. Additionally or alternatively, an example identifiable characteristic may include a geometry of the pill 504, which may include the dashed line 502 surrounding the pill 504 along with a three-dimensional aspect indicated by dashed lines 510. Additionally or alternatively, an example identifiable characteristic may include an inscription 512 on the pill 504. In the depicted embodiment, the inscription 512 includes text. However the inscription may include lines, shapes, indentations, trade names, trademarks, symbols, etc. Additionally or alternatively, an example identifiable characteristic may include a color of the pill 504.

Referring back to FIG. 1, the image of the unidentified pill is communicated to the network ID module 164 of the network server 112. The network ID module 164 may then analyze the image of the unidentified pill. In particular, the network ID module 164 of the network server 112 may be configured to receive the image from the patient device 104 via the network 140 and ascertain a best match of the unidentified pill from information stored in the medication database 168. Following analysis of the image, the network server 112 may then communicate match information to the patient device 104. The information communicated to the patient device 104 may then be presented to the patient 102.

The network ID module 164 may access the medication database 168. The medication database 168 may include information used in identifying the unidentified pill from the image and/or information related to identified pills. The network ID module 164 may also include components configured to access information from the medication database 168 to ascertain a match for the unidentified pill and/or otherwise process the image.

In the medication ID subsystem of the medication system 100, an example identification may begin by the patient device 104 generating an image such as a photograph of the unidentified pill. After the image is taken of the unidentified pill, the pill ID module 152 communicates the image to the network server 112 via the network 140. At the network server 112, the network ID module 164 may compare the image of the unidentified pill against images of identified pills included in the medication database 168 to ascertain best match. The best match may include one or more identified pills. The network ID module 164 may communicate the match information indicating the identified pills that are the best match to the patient device 104. The network ID module 164 may communicate additional information. For example, the additional information may include guidance or additional instructions that may be based on the degree of the match.

In the medication system 100 of FIG. 1, the pill ID module 152 receives the image of the unidentified pill from the camera 150, which is installed locally in the patient device 104. In some embodiments, the pill ID module 152 may interface with another camera, or may be configured to receive images from another device that includes a camera via the network 140.

Medication Adherence Subsystem

The medication system 100 of FIG. 1 may include the medication adherence subsystem. In the example medication adherence subsystem, adherence data may be calculated. In some embodiments, the medication adherence subsystem may further enable calculation of additional data related to the adherence data. The adherence data and the additional data may be calculated in substantially real-time. Accordingly, the medication adherence subsystem may result in the calculation of accurate and current adherence data with respect to the patient 102.

The medication adherence subsystem may include the network adherence module 166, the healthcare adherence module 172, the third party adherence module 174, the support entity adherence module 148, the network adherence module 166, and the patient adherence module 110. Generally, the adherence data may be calculated or otherwise generated at least in part by the patient adherence module 110 of the patient device 104 or the network adherence module 166. The patient device 104 may be readily available for access by the patient 102. Through interfacing with the patient adherence module 110, the patient 102 may provide input that may be used to generate the adherence data. Additionally, through interfacing with the patient adherence module 110, the adherence data may be communicated or reported to one or more of the third party 184 via the third party adherence module 174, the healthcare provider 144 via the healthcare adherence module 172, and the support entity 146 via the support entity adherence module 148. The patient adherence module 110 may also be configured to communicate or enable communication of information, additional data, interventions, or any other communication with the patient 102.

The patient adherence module 110 may be configured as an application that calculates the adherence data and at least partially enables scheduling of medications. Additionally or alternatively, the network adherence module 166 may be configured as an application that calculates of the adherence data and at least partially enables scheduling of medications at the network server 112. In some embodiments, processing may occur at both the patient device 104 and the network adherence module 166.

The patient adherence module 110 and/or the network adherence module 166 may calculate the adherence data and the additional data in substantially real-time. Substantially real-time may mean data is calculated or generated such that the patient 102 and/or another entity of the medication system 100 is notified or otherwise provided with data without material delay.

In these and other embodiments, the patient adherence module 110 and/or the network adherence module 166 may be configured to calculate adherence data based on a medications schedule. The medications schedule may be generated at the patient adherence module 110, the network adherence module 166, the support entity adherence module 148, the third party adherence module 174, the healthcare adherence module 172, or some combination thereof

For example, the medication schedule may be designed/configured for the patient 102. The medication schedule might include the identification of one or more medications and scheduled times for administering the medications. In some embodiments, the scheduled times of the doses of the medications may be automatically calculated by the patient adherence module 110 (or another module of the medications system 100). For example, the patient 102 may be prescribed a medication to be taken every eight hours for two weeks. The patient 102 may enter a name of the medication and the prescription and the patient adherence module 110 may automatically calculate the scheduled times at which doses of the medication are to be taken for the two weeks. Additionally or alternatively, the patient 102 or the healthcare provider 144 can manually input each scheduled time for one or more medications. In some embodiments, the patient 102 or the healthcare provider 144 may create the medication schedule using the user interface 190. The medication schedule may be saved locally on the patient device 104 or may be accessible via the network 140 at the network server 112.

The medication schedule may also include additional (or different) information, such as a graphical representation or picture of the medications, a dosage amount (e.g., one 400-milligram (mg) pill), and the like. The graphical representation or picture of the medications may be communicated from the medications database 168. Additionally or alternatively, in response to an inquiry submitted by the pill ID module 152, the graphical representation may be added to the medications schedule.

Based on the medication schedule, the patient 102 may be alerted to take a dose of a medication on the user interface 190, the display 134, the storage device display 192, or some combination thereof. In response, the patient 102 may generate a response signal that indicates she has taken the dose. Based on the response signal, the patient adherence module 110 and/or the network adherence module 166 may then calculate the adherence data.

The adherence data may include a medication adherence rate. The medication adherence rate may represent the percentage or portion of a medication the patient 102 is taking according to the medication schedule. For example, a medication may be prescribed to the patient 102 with the specification that the patient 102 is to take one pill every six hours for one week. If the patient 102 takes the first twenty-two pills every six hours, then stops taking the pills, then the medication adherence rate may be about 78.6%.

In some embodiments, the patient 102 may be concurrently taking multiple medications. The multiple medications may be unrelated or some combinations of the multiple medications may combine to treat one or more afflictions. For example, the adherence data may include one or more medication-specific adherence rates. The medication-specific adherence rates may be essentially identical to the medication adherence rate described above other than an accompanying identification of the medication.

Additionally or alternatively, an affliction-specific medication adherence rate may be calculated for one or more afflictions of the patient. The affliction-specific medication adherence rate may represent the percentage or portion of one or more medications a patient is taking according to a recommended schedule for a particular affliction. The affliction-specific medication adherence rate may include a total for all medications administered to treat a particular affliction and/or an enumerated list of each medication administered to treat the particular affliction. An example of an affliction-specific medication adherence rate may include a patient infected with tuberculosis who has Type 1 diabetes. The tuberculosis may be treated through a combination of medications taken over a period of time and the Type 1 diabetes may be treated through insulin injections over the course of the patient's life. A first affliction-specific medication adherence rate may be calculated for the tuberculosis and a second affliction-specific medication adherence rate may be calculated for the Type 1 diabetes. Additionally, a medication-specific adherence rate may be calculated for the insulin and/or one or more of the medications administered to treat the tuberculosis.

In some embodiments, an average medication adherence rate may be calculated. The average medication adherence rate may represent an average of two or more medication-specific adherence rates. Accordingly, the average medication adherence rate may be calculated by adding two or more medication-specific medication adherence rates and dividing the sum of the two or more medication-specific adherence rates by the number of the medication-specific adherence rates.

In addition to the adherence data, healthcare adherence may be calculated. For example, healthcare adherence rates may be calculated for one or more healthcare activities. The healthcare adherence rate may represent a percentage or portion of a healthcare activity in which the patient participates according to the medications schedule. The healthcare activities may include, but are not limited to, refilling prescriptions, keeping healthcare appointments, glucose testing, exercise, and blood pressure testing.

The illustrated exemplary medication system 100 generally represents a simplified system in which the data discussed above may be calculated and communicated. Although not shown, a system may also be provided that connects and enables communication of data from multiple patients. From this multiple-patient data, additional data may be calculated. For example, differentiator adherence rates may be calculated in such a system. The differentiator adherence rates may generally include medication adherence rates across a differentiator. The differentiator may include a population segmented by geography, a population segmented by disease state, a population segmented by co-morbidity, a specific medication, a medication class, or a particular treatment.

The adherence data and additional data, if applicable, may be communicated between the medication system components. The medication adherence subsystem may enable use of the adherence data by one or more of the third party 184, the healthcare provider 144, the charity 186, the sponsor 198, and the support entity 146. For example, the third party 184, the healthcare provider 144, and the support entity 146 may use the adherence data to modify or improve treatments provided to the patient 102, to set insurance premiums, to evaluate treatments, to monitor in real-time medication adherence of the patient 102, and/or to intervene on behalf of the patient 102.

At the medication system components, additional data may be derived from the adherence data and communicated among the various entities illustrated in FIG. 1. For example, the third party 184 may receive adherence data, derived additional data therefrom, and communicate the additional information to the healthcare adherence module 172, the patient adherence module 110, and/or the support entity adherence module 148. A particular example may be implemented in which the third party 184 is a healthcare payer, a governmental organization, a healthcare provider, an insurance company, a data processing company, or the like. The adherence data can be used by the third party 184 to set or modify insurance premiums (e.g., increasing insurance premiums based on adherence data indicating the patient fails to take medication). The third party 184 may then communicate the modified insurance premium to the healthcare provider 144, the support entity 146, the patient device 104, or any combination thereof.

Likewise, the healthcare provider 144 and/or the support entity 146 might exchange messages or information with the patient device 104 based on the adherence data. For example, the healthcare adherence module 172 may receive adherence data. In response, the healthcare provider 144 may communicate information related to the medication schedule to the patient adherence module 110 of the patient device 104, view or modify the medication schedule, create a medication schedule on the patient device 104 or on the network server 112, or some combination thereof.

Additionally, the healthcare provider 144 and the support entity 146 may communicate interventions to the patient adherence module 110 of the patient device 104 via the network 140. For example, in response to the patient 102 missing a dose of a medication, the healthcare provider 144 and/or the support entity 146 may communicate an intervention to the patient adherence module 110. The intervention may remind the patient 102 to take the missed dose.

Medication Adherence Monitoring Subsystem

The medication system 100 of FIG. 1 may include the medication adherence monitoring subsystem. Generally, the medication adherence monitoring subsystem may be configured to interface with the medication adherence subsystem. For example, the medication adherence monitoring subsystem may be responsive to adherence data and/or additional data calculated by the patient adherence module 110 and/or the network adherence module 166. Moreover, the medication adherence monitoring subsystem may include the patient adherence module 110 and/or the network adherence module 166 with one or more additional functionalities as described herein. In particular, the patient adherence module 110 and/or the network adherence module 166 may be configured to generate and communicate monitor alerts based on adherence data. The monitor alerts may be communicated to the support entity 146 at the notification module 154 or a healthcare provider 144 at the healthcare adherence module 172 via the network 140.

In some embodiments, the monitor alerts may be generated and/or communicated in substantially real-time. Accordingly, the support entity 146 and/or the healthcare provider 144 may have access to accurate and current adherence data and corresponding monitor alerts with respect to the patient 102. The support entity 146 and/or the healthcare provider 144 may accordingly be notified of circumstances triggering the monitor alert and may respond on information included in the monitor alert.

The monitor alerts may be generated based upon one or more monitor alert triggers. Generally, the monitor alert triggers may include a set a circumstances that prompt the generation and/or communication of a monitor alert. Standard or default monitor alert triggers may be selected by the patient 102, the healthcare provider 144, the support entity 146, another entity, selected by a system default (e.g., the patient adherence module 110 and/or the network adherence module 166), or any combination thereof.

The monitor alert triggers may also be customized in some embodiments. For example, the monitor alert trigger may be customized to the patient 102, may be customized to the support entity 146, may be customized to an affliction, may be defined by the third party 184 such as an insurance provider or payer according to a policy suggestion, or any other suitable trigger event. An example of a monitor alert trigger is missing a scheduled dose of a medication. In response to the patient 102 missing the scheduled dose, the patient adherence module 110 and/or the network adherence module 166 may generate and communicate a monitor alert. The monitor alert may be communicated to, for example, the support entity 146 at the notification module 154.

The monitor alert triggers may be based on patient response signals received (or not received, as the case may be) at the patient device 104. For example, when a dose of medication is missed (and not entered in the patient device 104 by the patient), a monitor alert may be generated and communicated. Likewise, when a dose of medication is taken (as indicated by a patient response entered at the patient device 104), a monitor alert may be generated and communicated.

The patient adherence module 110 may enable one or more of the monitor alert triggers and thresholds included therein to be defined. The thresholds may be based on a number of response signals, specific periods of time, one or more specific medications, one or more specific support entities 146 (in medication system with multiple monitors), one or more specific healthcare providers 144, one or more afflictions, similar factors, or any combination thereof.

For example, a patient, the support entity 146, the healthcare provider 144, or another entity may define one or more thresholds related to the adherence data, that when exceeded (or otherwise missed), trigger the generation and/or communication of a monitor alert. For example, a threshold number of response signals may be defined as a monitor alert trigger. When the threshold number of response signals is not received during a specified period of time (for example, the patient simply is not providing input), a corresponding monitor alert may be generated and communicated. Some additional examples of monitor alert triggers may include, a threshold number of response signals are not received pertaining to a medication; a response signal of a current dose of a medication corresponding to the scheduled time is not received; a response signal is not received for a critical medication; other adherence data is below a minimum threshold; and data related to healthcare adherence of a healthcare activity is below a minimum threshold.

Additionally, the monitor alert triggers may be based on a predetermined circumstance of the patient device 104. For example, a monitor alert trigger may be based on the physical location of the patient device 104 (based, for example, on GPS data), inactivity of the patient device 104, or any other device-based indicator. For example, in embodiments in which the patient device 104 is a mobile device, a monitor alert trigger may be configured to generate a monitor alert when a patient is in a suspect area of a metropolitan area during a specific time period.

In some embodiments, a monitor alert may include at least a portion of the adherence data. For example, the monitor alert may be generated and communicated based on the adherence data. The monitor alert may accordingly include the relevant portion of the adherence data. For example, the monitor alert may be generated in response to the patient 102 missing a dose of a medication. The generated monitor alert may indicate that the patient 102 missed a scheduled dose of the medication. The generated monitor alert may be communicated to the support entity 146 and/or the healthcare provider 144. In response, the support entity 146 and/or the healthcare provider 144 may call, text, or email the patient 102 to remind the patient 102 to take the dose of the medication. Similarly, the monitor alert may indicate that a particular adherence data is below a defined threshold.

An example of a medications monitoring operation may include the patient 102 selecting via the patient adherence module 110 the support entity 146 and/or the healthcare provider 144 as monitors for at least some portion of monitor alerts. One or more monitor alert triggers may be defined based on input from the patient 102, the healthcare provider 144, the support entity 146, or some combination thereof. Based on the medications schedule, the patient 102 is alerted to take a dose of a medication. In response, the patient 102 may generate (or not generate) a response signal that indicates she has taken the dose. For example, the patient 102 may select an icon presented on the user interface 190.

Based on the response signal, the patient adherence module 110 and/or the network adherence module 166 may calculate in substantially real-time the adherence data. The adherence data may form one or more of the circumstances under which a monitor alert is triggered, as governed by the monitor alert triggers. Thus, monitor alerts may be generated based on substantially real-time adherence data. The monitor alert may then be communicated to the notation module 154 and/or the healthcare adherence module 172. In response, the healthcare provider 144 and/or the support entity 146 may communicate a response message to the patient 102 at the patient adherence module 110 or another system of the patient device 104 (e.g., a SMS text message).

In some embodiments, the support entity device 118 may not receive monitor alerts at the notification module 154. Instead, the support entity device 118 may receive the monitor alert via the network 140 as a SMS text, etc. Additionally or alternatively, a computing device other than the healthcare provider server 114 may be associated with the healthcare provider 144. The computing device may be communicatively coupled to the network 140 and/or the healthcare provider server 114 such that the monitor alerts may be communicated thereto.

Charitable Donation Subsystem

The medication system 100 of FIG. 1 may include the charitable donation subsystem. In the illustrated medication system 100, adherence data of the patient 102 may be calculated as described herein. Based on an adherence “success,” donations may be contributed to the charity 186. For example, donations or donation amounts might be based on the patient 102 achieving target levels of medication adherence (target levels).

Generally, the target levels may include a set a circumstances that prompt the contribution of a donation to the charity 186. Depending on a particular implementation's needs and objectives, the target levels may be defined or selected by the patient 102, the healthcare provider 144, the sponsor 198, the charity 186, another entity, selected by a system default, or any combination thereof.

A particular target level may be based on adherence data, some portions thereof, or additional data derived from adherence data. Additionally, a target level may be defined in relationship to a period of time. For example, if a target level is achieved during a prescribed period of time, donations are contributed to the charity 186. The target levels may be set or otherwise designed so as to maximize the incentive for the patient 102 to adhere to a medication schedule. Some additional examples of target levels might include a number of response signals received pertaining to a medication; reception of a response signal of a current dose of a medication corresponding to the scheduled time; a response signal is received for a critical medication; other adherence data above a defined threshold; and data related to healthcare adherence of a healthcare activity is above a defined threshold.

In some embodiments, multiple target levels may also be defined or selected for multiple charities. The multiple target levels may result in contributions of multiple donations to one or more of the multiple charities. For example, a first target level may include taking a dose of a first medication each day. The first target level might result in a contribution of a first donation to a first charity (e.g., the charity 186). A second target level might include a successful un-interrupted period of medication adherence such as taking a second medication for a year. Achievement of the second target level may result in a second donation to a second charity. Any one of a different number of targets and reward mechanisms can be used.

The patient 102, the charity 186, the sponsor 198, the healthcare provider 144, or another entity may define or select one or more target levels based on the adherence data. The charity 186 may be selected by the patient 102, which may in turn incentivize medication adherence on the part of the patient 102. In some embodiments, the patient adherence module 110 may further track and/or display the adherence data, some indication thereof, resulting donations, or some combination thereof, which may further motivate the patient 102.

The donations may be contributed to the charity 186 from the patient 102, from the sponsor 198, or both. For example, a donation account (not shown) may be linked to the charity 186 from which monetary funds can be transferred to the charity 186 upon an achievement of a target level. The donation account can be funded by the patient 102 and/or the sponsor 198 via transactions made over the network 140, in some embodiments. Additionally or alternatively, the donation might be in the form of a “prize” incentive that is contributed to the charity 186. Such a prize could be awarded to the charity 186 upon completion of a defined number of incentives on the part of a patient or group of patients.

The patient adherence module 110 and/or the network adherence module 166 may be configured to enable the target levels to be defined, achievement of target levels to be assessed, and donations to be contributed to the charity 186. In these and other embodiments, the patient adherence module 110 and/or network adherence module 166, or an application loaded thereon may be configured to assess achievement of target levels in substantially real-time.

An example of a contribution operation may include the patient 102 selecting the charity 186 via the patient adherence module 110. The charity 186, once selected, is a recipient for at least some portion of donations. One or more target levels may be configured based on input from the patient 102, the healthcare provider 144, the support entity 146, or some combination thereof. Based on the medications schedule, the patient 102 is alerted to take a dose of a medication as described herein. In response, the patient 102 may generate a response signal that indicates she has taken the dose. For example, the patient 102 may select an icon presented on the user interface 190.

Based on the response signal, the patient adherence module 110 and/or the network adherence module 166 may calculate in substantially real-time the adherence data. Assessment of achievement of the target levels may be based on substantially real-time adherence data. In response to the adherence data may forming one or more of the circumstances of the target level, a donation based on the target level may be transferred to the charity 186. Additionally or alternatively, an indication of the donation may be communicated to the charity adherence module 176.

Medication Dispensation Subsystem

The medication system 100 of FIG. 1 may include the medication dispensation subsystem. The medication dispensation subsystem may include the storage device 132 that facilitates, among other functions, medication compliance on the part of the patient 102. To do so, dose information and alerts can be locally displayed via the storage device display 192 per the medication schedule. The patient 102 can be reminded of a scheduled dose via an alert generated by the storage device adherence module 182 or generated by the patient adherence module 110 or the network adherence module 166 and communicated to the storage device 132. The alert may be provided via a visual and/or audible signal.

The storage device 132 may also determine whether the patient has administered the medication dose by way of a response signal, which indicates compliance with the medication schedule. For example, generation of the response signal indicates that the patient 102 physically retrieved (and presumptively administered) the dose of the medication from the corresponding location in the storage device 132 at the scheduled day and time. The response signal may be generated through triggering of a bay sensor and/or via input received at the user interface 190 of the patient device.

Upon compliance, the storage device 132 may then generate a medication confirmation signal. The medication confirmation signal indicates that the response signal has been received for a scheduled dose. From the medication confirmation signal, the adherence data of the patient 102 can be generated by the patient adherence module 110 and/or the network adherence module 166. The adherence data may be displayed (via display 134B for example) at the storage device 132 and/or communicated throughout the medication system 100 via network 140.

For example, the storage device adherence module 182 may locally display on the storage device display 192 dose information relating to doses of medications included in the medication schedule. The dose information may be related to a next dose, the doses for the day, or any other amount of information. Additionally, the dose information may include a quick response (QR) code that may be scanned to provide the patient 102 or the support entity 146 additional dose information.

Within a particular time interval of a scheduled time of a dose (e.g., five minutes), the storage device adherence module 182 may alert the patient 102 of the dose. The alert may generated locally or communicated from another device. In response to the alert being received by the storage device adherence module 182, the storage device adherence module 182 may display dose information related to a dose included in the alert.

After alerting the patient 102, the storage device adherence module 182 may determine whether a response signal is received. For instance, in embodiments of the storage device 132 including a bay access sensor, when the bay access sensor is triggered, the storage device adherence module 182 may interpret access to a bay corresponding to a location of the dose as a response signal.

The response signal may also be generated at the patient device 104. For example, some embodiments of the storage device 132 may not include the sensors 136 configured to measure whether the patient 102 has accessed a bay in which a dose is located. Instead, an alert may be triggered on the storage device 132 and the patient device 104. The patient 102 may then administer the dose and interact with the patient device 104 (e.g., activate an action button or an icon on the display 134) to generate the response signal, thereby indicating that the medication has been administered. The patient adherence module 110 then communicates the response to the storage device 132 or uses it locally as described herein.

In response to reception of a response signal, the storage device adherence module 182 may generate a medication confirmation signal. The storage device adherence module 182 may calculate adherence data based on the medication confirmation signal or communicate the medication confirmation signal to the patient device 104 or one or more of the medication system components.

In some embodiments, the storage device 132 may be paired with the patient device 104. By pairing the storage device 132 with the patient device 104, data communicated to the storage device 132 may be shared with the patient device 104 and vice versa. Moreover, pairing the patient device 104 with the storage device 132 may include periodic synchronization of data stored in the memories of the patient device 104 and the storage device 132. For instance, by pairing the storage device 132 and the patient device 104, an alert may be displayed on the display 134 and the storage device display 192 simultaneously or substantially simultaneously.

In some embodiments, the storage device adherence module 182 may also enable synchronization between one or more of the medication system components or modules/applications hosted thereon. The synchronization may enable continuous or periodic communication of data via the network 140 such that each of the modules/applications includes up-to-date and substantially consistent information. Accordingly, the medication system 100 may result in the calculation of current adherence data with respect to the patient 102 and the medication adherence components. For example, changes and updates to a medication schedule of the patient 102 may be continuously or periodically communicated among the medication system components. The storage device 132 may accordingly have the medication schedule in real-time or substantially real-time following a modification. Additionally, the medication confirmation signals may be communicated from the storage device 132 in real-time or substantially real-time to the network server 112 or the patient device 104, which may enable real-time or substantially real-time calculation of adherence data.

After synchronizing, the patient device 104 and/or the storage device 132 may operate independently as described herein. Upon a subsequent synchronization, data generated on the patient device 104 and/or the storage device 132 may be communicated to the medication system components and data changes may be synchronized.

Additionally, the storage device adherence module 182 may be configured to enable interaction with the patient 102. Specifically, in some embodiments, the storage device adherence module 182 may be configured to receive a medication schedule authored by or modified by one or more of the patient 102, the support entity 146, or the healthcare provider 144. For example, the storage device adherence module 182 may be configured to receive the medication schedule or an updated medications schedule.

Additionally in the depicted embodiment, the healthcare provider server 114 may include the order module 138. The order module 138 may interface with the storage device adherence module 182 to order prescriptions of the patient 102. For example, based on a medication confirmation signal, the storage device adherence module 182 and/or the healthcare adherence module 172 may determine whether a prescription including a dose of the medication confirmation signal is exhausted. In response to the prescription being exhausted, the storage device adherence module 182 and/or the healthcare adherence module 172 may order a refill of the prescription. The order may be communicated to the order module 138 that may be configured to order the prescription from the healthcare provider 144. In response to the prescription not being exhausted, the storage device adherence module 182 and/or the healthcare adherence module 172 may update a number of doses remaining of the prescription.

Modifications, additions, or omissions may be made to the medication system 100 without departing from the scope of the present disclosure. For example, while FIG. 1 depicts one of each of the medication system components, the present disclosure applies to a medication system architecture having one or more of any of the medication components, one or more patients 102, one or more of the support entities 146, one or more charities 186, one or more sponsors 198, or any combination thereof. Moreover, the separation of the medication system components in the embodiments described herein should not be understood as requiring such separation in all embodiments, and it should be understood with the benefit of this disclosure that the described medication system components can generally be integrated together in a single component or server or separated into multiple components or servers.

One or more of the network ID module 164, the network adherence module 166, the order module 138, the healthcare adherence module 172, the third party adherence module 174, the charity adherence module 176, the support module 162, the notification module 154, the support entity adherence module 148, the storage device adherence module 182, the patient adherence module 110, and the pill ID module 152 (collectively modules) can be code and routines for facilitating, encouraging, and measuring medication adherence of the patient 102 and/or medication identification. In some embodiments, the modules acts in part as a thin-client application that may be stored on one or more of the patient device 104 and/or the storage device 132, for instance, and in part as components that may be stored on one or more of the medication system components. In some embodiments, one or more of the components can be implemented using hardware including a field-programmable gate array (FPGA) or an application-specific integrated circuit (ASIC). In some other instances, the modules can be implemented using a combination of hardware and software. In some embodiments, the modules may be stored in a combination of the medication system components.

In the medication system 100, memory can be a non-transitory memory that stores data for providing the functionality described herein. The memory may be included in storage that may be a dynamic random access memory (DRAM) device, a static random access memory (SRAM) device, flash memory, or some other memory devices. In some embodiments, the storage also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

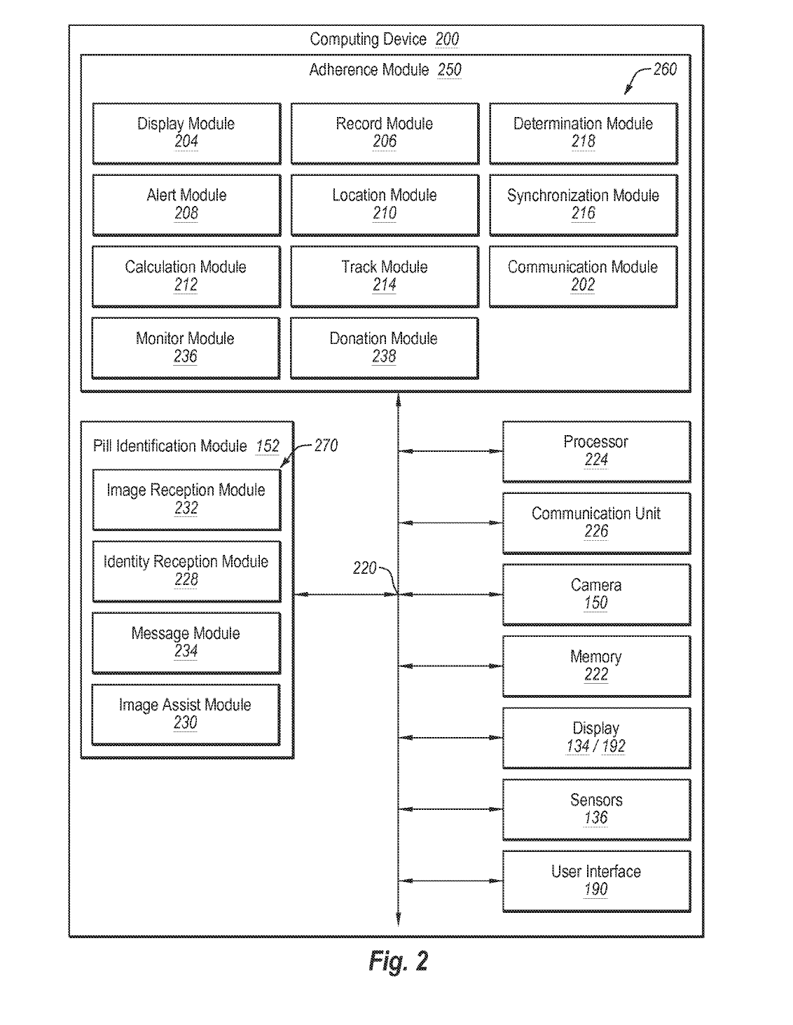

FIG. 2 illustrates a block diagram of an example embodiment of a computing device 200 that may be implemented in the medication system 100 of FIG. 1. Generally, the computing device 200 may include one of the medication system components described with reference to FIG. 1.

The computing device 200 includes an example of an adherence module 250 that may perform one or more of the operations of the network adherence module 166, the healthcare adherence module 172, the third party adherence module 174, the charity adherence module 176, the support module 162, the support entity adherence module 148, the storage device adherence module 182, and the patient adherence module 110 discussed with reference to FIG. 1. Additionally, the computing device 200 includes an example of the pill ID module 152, which is depicted in FIG. 2 in more detail. The computing device 200 also includes the sensors 136, the user interface 190, the camera 150, the display 134 or the storage device display 192 (collectively depicted in FIG. 2 as display 134/192), a processor 224, a memory 222, and a communication unit 226. The components of the computing device 200 are communicatively coupled by a bus 220. The computing device 200 is described with reference to FIGS. 1 and 2.

The processor 224 may include an arithmetic logic unit, a microprocessor, a general purpose controller, or some other processor array. The processor 224 may be coupled to the bus 220 for communication with the other components. The processor 224 processes data signals and may include various computing architectures including a complex instruction set computer (CISC) architecture, a reduced instruction set computer (RISC) architecture, or an architecture implementing a combination of instruction sets. Although FIG. 2 includes a single processor 224, multiple processors may be included in the computing device 200. Other processors, operating systems, and physical configurations are possible.

The memory 222 is configured to store instructions and/or data that may be executed by or controlled by the processor 224. The memory 222 is coupled to the bus 220 for communication with the other components. The instructions and/or data may include code for performing the techniques or methods described herein. The memory 222 may be a dynamic random access memory (DRAM) device, a static random access memory (SRAM) device, flash memory, or some other memory device. In some embodiments, the memory 222 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

The communication unit 226 may be configured to transmit and receive data to and from the medication system components depending upon where the adherence module 250 is stored. The communication unit 226 is coupled to the bus 220. In some embodiments, the communication unit 226 includes a port for direct physical connection to the network 140 or to another communication channel. For example, the communication unit 226 may include a USB, SD, CAT-5 or similar port for wired communication. In some embodiments, the communication unit 226 includes a wireless transceiver for exchanging data via communication channels using one or more wireless communication methods, including IEEE 802.11, IEEE 802.16, BLUETOOTH® or another suitable wireless communication method.

In some embodiments, the communication unit 226 includes a cellular communications transceiver for sending and receiving data over a cellular communications network including via SMS, MMS, HTTP, direct data connection, WAP, email or another suitable type of electronic communication. In some embodiments, the communication unit 226 includes a wired port and a wireless transceiver. The communication unit 226 may also provide other conventional connections to the network 140 for distribution of files and/or media objects using standard network protocols including TCP/IP, HTTP, HTTPS, and SMTP, etc.

In embodiments including the user interface 190, the sensors 136, the camera 150, and the display 134/192, each of these components are coupled to the bus 220 along with the adherence module 250 and the pill ID module 152. The display 134/192 and the sensors 136 may accordingly communicate with first modules 260 included in the adherence module 250 and the modules 270 included in the pill ID module 152.

In the embodiment shown in FIG. 2, the adherence module 250 includes a communication module 202, a display module 204, a record module 206, an alert module 208, a location module 210, a calculation module 212, a track module 214, a synchronization module 216, a determination module 218, a monitor module 236, and a donation module 238 (collectively, the first modules 260). Additionally, the pill ID module 152 depicted in FIG. 2 includes an image reception module 232, an identity reception module 228, a message module 234, and an image assist module 230 (collectively, second modules 270).

One or more of the first modules 260 and the second modules 270 may be implemented as software including one or more routines configured to perform one or more operations. The first and second modules 260 and 270 may include a set of instructions executable by the processor 224 or the execution of which is controlled by the processor 224 to provide the functionality described herein. In some instances, the first and second modules 260 and 270 may be stored in or at least temporarily loaded into the memory 222 and may be accessible and executable by the processor 224. One or more of the first and second modules 260 and 270 may be adapted for cooperation and communication with the processor 224 and components of the computing device 200 via the bus 220.

The communication module 202 may be configured to handle communications between the adherence module 250 and other components of the computing device 200. The communication module 202 may be configured to send and receive data, via the communication unit 226, to and from the medication system components of FIG. 1. In some instances, the communication module 202 may cooperate with the other modules 204, 206, 208, 210, 212, 214, 216, 218, 236, and 238 to receive and/or forward, via the communication unit 226, data from the medication system components of FIG. 1.

For example, the communication module 202 may receive, via the communication unit 226, a pairing request and/or a synchronization request. The pairing request may initiate a pairing between one or more of the medication system components and the storage device 132. The pairing request may be communicated from the communication module 202 to the synchronization module 216. The synchronization request may initiate a synchronization operation between two or more of the medication system components. The synchronization request may be communicated from the communication module 202 to the synchronization module 216.

In response to the pairing request, the synchronization module 216 may pair two or more of the medication system components. For example, the storage device 132 may be paired with the patient device 104 and/or the network server 112. After the storage device 132 is paired with the patient device 104 and the network server 112, data communication between the storage device 132, the patient device 104, and the network server 112 may be automatic or semi-automatic such that the data on each of the storage device 132, the patient device 104, and the network server 112 may be accurate and current.

Similarly, the synchronization module 216 may synchronize two or more of the medication system components. For example, the storage device 132 may be synchronized with the patient device 104, the network server 112, and the healthcare provider server 114.

A synchronization operation may update the data and information locally stored on each of the medication system components such that each of the medication system components includes an up-to-date version. For example, the adherence module 250 may enable local modifications to a medications schedule. Performance of the synchronization operation may ensure that each of the medication system components include medications schedule that reflect the local modifications. Following synchronization, each of the storage device 132, the patient device 104, and the network server 112 may have stored in the memory 222 an accurate and current medication schedule.

The data synchronized may include a medication schedule of the patient 102, a number of doses remaining for the patient 102, adherence data, additional data derived from the additional data, donation records, monitor alerts, and the like. In the described example, synchronization may be performed in response to a synchronization request. Additionally, synchronization may be performed according to a schedule. For instance, the storage device 132 may be loaded each week. Accordingly, the synchronization module 216 may synchronize the storage device 132 each week.

The communication module 202 may additionally receive a fill signal. The fill signal may originate at one of the sensors 136. For example, the computing device 200 may include the sensors 136 that generate the fill signal. The fill signal may be communicated from one of the sensors 136 to the communication module 202 via the bus 220. In some embodiments, the fill signal may indicate medications are loaded in the storage device 132 according to the medication schedule, which may be received during synchronization. The fill signal may additionally indicate that the storage device 132 is prepared to facilitate in dispensation and medication adherence of the patient 102.

The communication module 202 may receive dose information of a dose of a medication. The dose information may be received from a medication schedule in the memory 222 via the bus 220. Additionally, the dose information may be received from the determination module 218 according to a physiological measurement made by a physiological sensor included as one of the sensors 136. The communication module 202 may then communicate the dose information to the display module 204. The display module 204 may receive the dose information from the communication module 202 communicate the dose information to the display 134/192.

The dose information may include a time of day, dose, and a graphical representation of an upcoming dose of a medication. For example, if the patient 102 is prescribed one aspirin at 8:00 AM, the display 134 and/or the storage device display 192 may include the dose information of “one aspirin at 8:00 AM” along with a photograph of the aspirin.

The communication module 202 may receive an alert of the dose. The alert may be received from medication schedule in the memory 222 via the bus 220. Additionally or alternatively, the alert may be received from one or more of the medication system components via the communication unit 226. The communication module 202 may then communicate the alert to the alert module 208.

The alert module 208 may receive the alert and communicate the alert such that the patient 102 becomes aware of the upcoming dose. In some embodiments, the alert may be communicated within a particular interval of when the dose is to be administered. For instance, if one aspirin is to be administered at 8:00 AM, the alert may be communicated at 7:55 AM.

The alert may be communicated to the display module 204, which may communicate the alert to the display 134/192. Additionally, the alert module 208 may communicate the alert to the communication module 202, which may communicate the alert to one or more of the medication system components via the communication unit 226. Additionally still, the alert module 208 may generate an alert signal. The alert signal may trigger a light, an audio alarm, a vibration, any combination thereof, or any other suitable alert. The alert signal may be communicated to a component (e.g., a bulb, a speaker, etc.) to implement the alert.

In some embodiments, the alert may include an audio signal such as a beep, a local visual indication such as light on a bay of the storage device 132 in which the medication is located, and a display of dose information on the display 134 and the storage device display 192. Thus, when the patient 102 is to administer a dose of a medication, the patient device 104 and the storage device 132 includes dosing information with a graphical image of the medication. Additionally, there is a light indicating which bay to open to obtain the medication.

The determination module 218 may determine whether a response signal has been or has not been received. The response signal may be communicated by one of the sensors 136, for instance. The response signal may be generated by a bay access sensor, which may indicate a bay of the storage device 132 was opened, for instance. Additionally, the response signal may be generated by the patient 102 interacting with the user interface 190 on the patient device 104 and/or the website 126. For instance, the patient 102 may touch an alert icon or select an alert icon using a mouse, a keyboard, an audible receiver, etc.

In response to a determination that the response signal has not been received (e.g., the medication has not been administered), the determination module 218 may communicate a dose failure signal to the communication module 202. The communication module 202 may further communicate the dose failure signal to one or more of medication system components via the communication unit 226, to the calculation module 212, and to the alert module 208. In response to reception of a dose failure signal, a warning may be generated by the alert module 208. The warning may be communicated to one or more of the medication system components and/or to the display module 204, and then to the display 134/192. Additionally, after a particular interval (e.g., 5 or 10 minutes) the calculation module 212 may calculate adherence data including missed dose.

In response to a determination that the response signal has been received (e.g., the medication has been administered), the determination module 218 may communicate a signal indicating reception of a response signal to the record module 206. In response to the signal from the determination module 218, the record module 206 may record the medication confirmation signal. The record module 206 may communicate the medication confirmation signal to the track module 214, the calculation module 212, one or more of the medication system components, or some combination thereof.

The track module 214 is configured to track prescription exhaustion based on the medication confirmation signals. In response to the medication confirmation signal communicated from the record module 206, the track module 214 may determine whether a prescription including the dose is exhausted. In response to the prescription being exhausted, the track module 214 may communicate a signal to order a refill of the prescription. In response to the prescription not being exhausted, the track module 214 may update a number of doses remaining of the prescription. For example, the track module 214 may communicate an order to the order module 138.

In response to the medication confirmation signal communicated from the record module 206, the calculation module 212 may calculate adherence data including an administered dose. In some embodiments, the adherence data may be communicated to the display module 204, and then communicated to the display 134/192.

Additionally, the adherence data may be calculated at one or more of the medication system components based on the medication confirmation signal. The adherence data may be received by the communication module 202. The communication module 202 may communicate the adherence data to the display module 204, which may communicate the adherence data to the display 134.

After one or more adherence data calculations, the monitor module 236 may determine whether the adherence data meets a monitor alert trigger and the donation module 238 may determine whether the adherence data meets a target level of adherence. In response to the adherence data meeting monitor alert trigger, the monitor module 236 may communicate a monitor alert to a selected monitor. In response to the adherence data meeting a target level of adherence, the donation module 238 may initiate a transfer of funds to the charity 186.

The communication module 202 may additionally receive a location inquiry. The location inquiry may be received from one or more of the medication system components via the communication unit 226. For example, the patient 102 may generate a location inquiry at the patient device 104 and communicate the location inquiry to the storage device 132. The location inquiry may be communicated to the location module 210.

In response to the location inquiry, the location module 210 may transmit a location signal. The location signal may be a position of the computing device 200 based at least partially on a positioning signal. The location module 210 may include or receive positioning information from a positioning receiver (not shown). An example of the positioning receiver may be a global positioning signal (GPS) receiver. The location module 210 may additionally or alternatively include a wireless fiber (Wi-Fi) positioning receiver, or any other suitable positioning receiver that may generate and/or communicate positioning information. The location module 210 may communicate location signal to one or more of the medication system components. The location signal may be used to locate the computing device 200. Additionally, the location module 210 may communicate location signal to the memory 222, which may store the location signal. In some embodiments, a monitor signal may be generated based on the location signal.

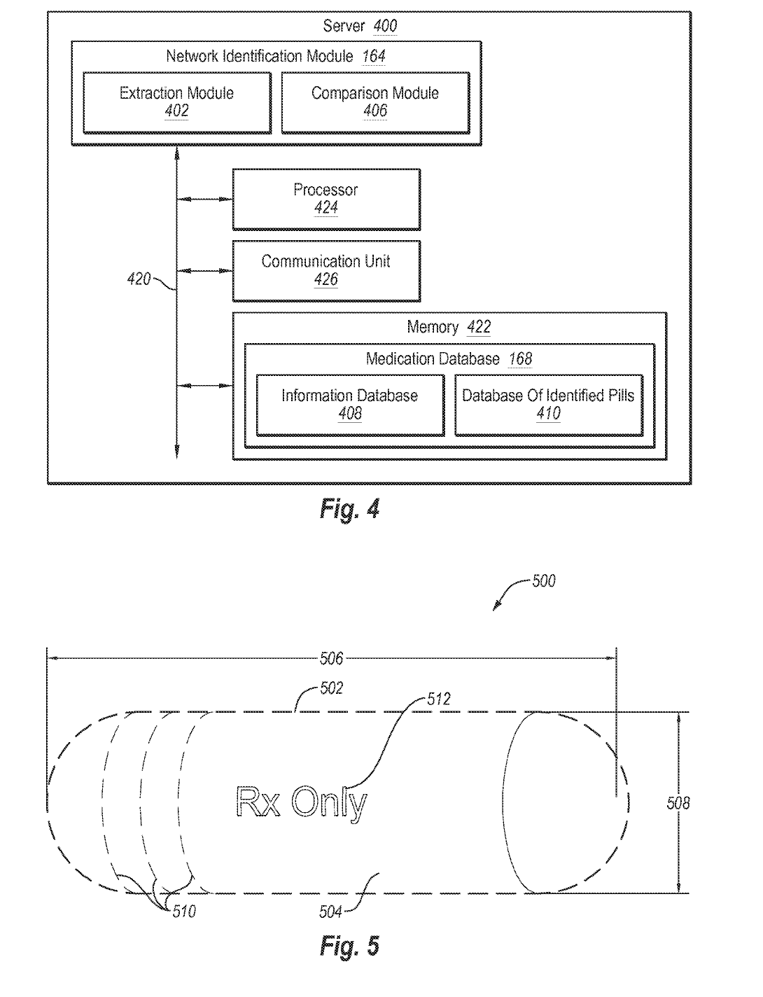

The pill ID module 152 is described with reference to FIGS. 1, 2, and 4. FIG. 4 illustrates an example server 400 including an example of the network ID module 164 of FIG. 1. The server 400 may include a portion of the network server 112. The server 400 includes the network ID module 164, a processor 424, a communication unit 426, a memory 422, and a bus 420. The processor 424, the communication unit 426, the memory 422, and the bus 420 are substantially similar to the processor 224, the communication unit 226, the memory 222, and the bus 220 of the computing device 200. The memory 422 includes an example of the medication database 168 that includes an information database 408 and a database of identified pills 410.

The network ID module 402 includes an extraction module 402 and a comparison module 406. The extraction module 402 and/or the comparison module 406 may be implemented as software including one or more routines configured to perform one or more operations. The extraction module 402 and/or the comparison module 406 may include a set of instructions executable by the processor 424 or the execution of which is controlled by the processor 424 to provide the functionality described herein. In some instances, the extraction module 402 and/or the comparison module 406 may be stored in or at least temporarily loaded into the memory 422 and may be accessible and executable by the processor 424. The extraction module 402 and/or the comparison module 406 may be adapted for cooperation and communication with the processor 424 and components of the server 400 via the bus 420.

With combined reference to FIGS. 1, 2, and 4, the image assist module 230 may interface with the camera 150 and/or the display 134/192 to assist the patient 102 in generating an image that includes identifiable characteristics. For example, the image assist module 230 may include an overlay on a range finder of the camera 150 such that the unidentified pill is properly sized within the image. Additionally, the image assist module 230, when activated, may provide posing instructions to the patient 102, such that the patient 102 properly orients the unidentified pill prior to generating the image.

The image reception module 232 may receive the generated image. The message module 234 may generate a message including the image. The message may be specifically formatted or otherwise suited for the server 400. The message may be communicated via the network 140 to the server 400.

In the server 400, the network ID module 164 is configured to interface with the computing device 200 such that the message including the image can be analyzed. In particular, the extraction module 402 may receive the message from the pill ID module 152 and extract the image from the message. The image extracted from the message may include the identifiable characteristics. The extraction module 402 may be configured to extract the identifiable characteristics from the image. For example, the extraction module 402 may analyze the image to extract a shape, a height/width ratio, a geometry, a color, an inscription, or some combination thereof from the image.

The comparison module 406 may compare the image and/or the identifiable characteristics to images and other data in the database of identified pills 410. A best match between the unidentified pill and one or more of the identified pills may be ascertained based on commonalities between the unidentified pill and one or more of the identified pills and/or commonalities between identifiable characteristics extracted from the image of the unidentified pill and identifiable characteristics of one or more of the identified pills. The images of the identified pill and/or identifiable characteristics of the identified pills may be stored in a database of identified pills 410. The comparison module 406 may access the images of the identified pills 410 and/or identifiable characteristics of the identified pills during the comparisons.

The database of identified pills 410 may include images and/or identifiable characteristics of identified prescription medications, over-the-counter (OTC) medications, vitamins, illegal pills, and objects commonly mistaken as medication. Accordingly, the comparison module 406 may distinguish between a prescription medication and a jellybean. Additionally, the database of identified pills 410 may be updatable. By updating the database of identified pills 410, new medications, new illegal pills, etc. may be added to the database of identified pills 410 as well as identified pills that are no longer in distribution or being prescribed may be removed. When the comparison module 406 ascertains the best match, match information may be generated indicating the one or more identified pills that the unidentified pill most resembles based on the identifiable characteristics.

In some embodiments, the server 400 may include an information database 408. The information database 408 may include information pertaining to the identified pills. For example, the information may include guidance as to appropriate actions to take when encountering the identified pill, information to aid in patient safety, legal status of the identified pill, drug interactions, etc.

In these and other embodiments, when the match information indicates a best match for an unidentified pill is one or more specific identified pills, the additional information pertaining to the specific identified pills may be obtained from the information database 408. The additional information may be included with match information by the comparison module 406.

In some circumstances, the match information may indicate that the unidentified pill most resembles multiple identified pills in the database of identified pill 410. Accordingly, the information database 408 may include one or more instructions to communicate to the patient 102. For example, an instruction may direct the patient 102 to resubmit the image with a particular identifiable characteristic visible or with better resolution.

In some embodiments, the additional information and the match information may be communicated concurrently. Alternatively, the match information may be communicated with an option to receive the additional information. Alternatively still, the match information may be communicated and after some predetermined time the additional information may be communicated.

Following the comparison by the comparison module 406, the match information and/or the additional information may be communicated to the identity reception module 228. The match information and/or the additional information may be included in a message formatted or otherwise specifically suited from reception by the computing device 200 having the pill ID module 152. The identity reception module 228 may then present the match information and/or the additional information (e.g., at the display 134/192). In this and other embodiments images and information may also be communicated between the computing device 200 and the server 400 via MMS message and/or email message.

In the embodiment described above, the patient 102 is using the pill ID module 152. In other embodiments other individuals (e.g., 146 or another individual) may use the pill ID module 152. Additionally, in the embodiment described above, the computing device 200 includes only the second modules 270. In other embodiments, the computing device 200 may include the second modules 270 as well as the extraction module 402, the comparison module 406, the medication database 168, or some combination thereof.

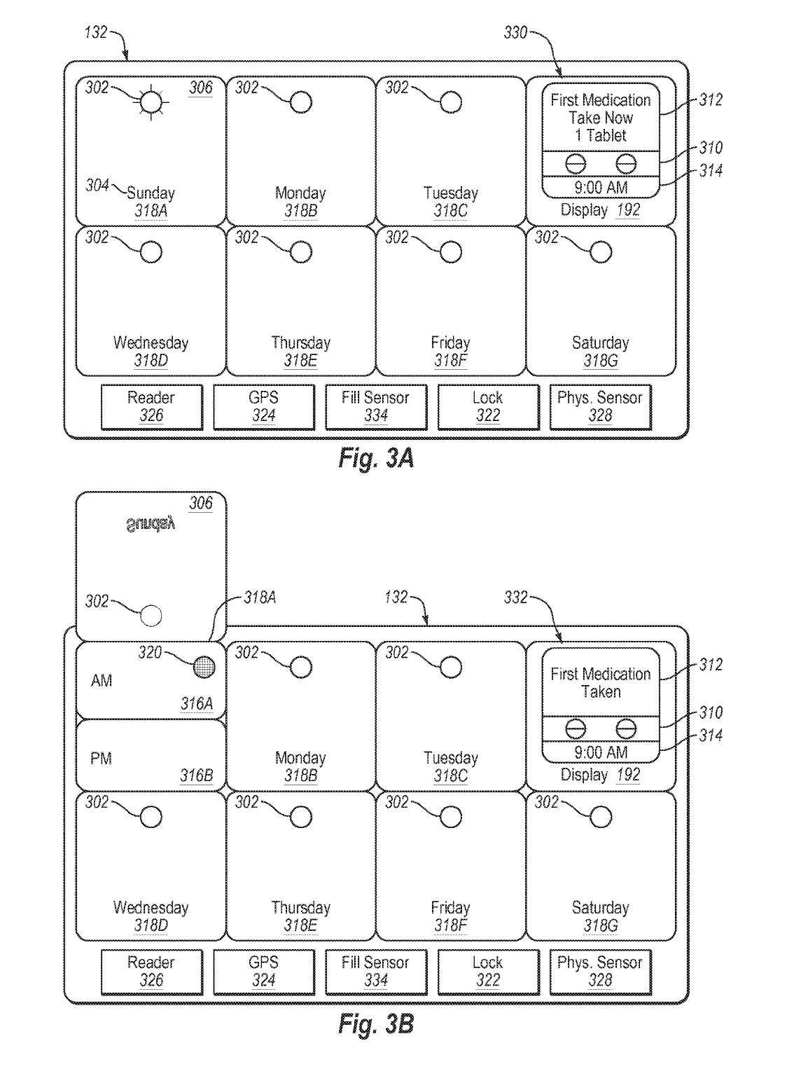

FIGS. 3A and 3B illustrate block diagrams of an example embodiment of the storage device 132 of FIG. 1. In FIG. 3A, the storage device 132 is depicted with bays 318A-318G (generally, bay 318 or bays 318) in a closed position. In FIG. 3B, the storage device 132 is depicted with a door 306 of a Sunday bay 318A in an open position. The storage device 132 depicted in FIGS. 3A and 3B is rectangular in shape and the bays 318 are designated according to days of the week (in FIGS. 3A and 3B, Sunday, Monday, Tuesday, Wednesday, Thursday, Friday, Saturday, and Sunday). Additionally, as illustrated in FIG. 3B, one or more of the bays 318 may be further separated into sub-bays 316A and 316B between a morning dose and an evening does (in FIG. 3B, AM 316A and PM 316B). As mentioned above, the storage device 132 may have another shape with one or more bays 318 designated according to another convention.

In some embodiments, one or more of the bays 318 may be removable. For instances, the Sunday bay 318A, a Monday bay 318B, a Tuesday bay 318C, and the display 134B may be removed from the other bays (e.g., 318D, 318E, 318F, and 318G). The removed bays may then be reattached and another subset of the bays 318 may be removed.

With reference to FIGS. 3A and 3B, the depicted storage device 132 includes a fill sensor 334. The fill sensor 334 may be configured to receive an input indicating that the storage device 132 has been loaded. For example, a medication schedule may be displayed on the storage device display 192. In response, a user of the storage device (e.g., the patient 102 of FIG. 1) may load doses of medications into each of the bays 318. When the user has loaded the doses of the medication into the bays 318, the user may actuate the fill sensor 334. The fill sensor 334 may include a button, a switch, or any other suitable user interface. Additionally, in some embodiments, the fill sensor 334 may be a particular icon (not shown) that may be displayed on the storage device display 192.

The storage device 132 also includes a physiological sensor 328 (in FIGS. 3A and 3B “Phy. Sensor 328”). The physiological sensor 328 may be configured to measure a physiological state of a patient. The physiological sensor 328 then communicates a measurement of the physiological state to a processor or module (e.g., the processor of FIG. 1, the processor 224 of FIG. 2, or the determination module 218 of FIG. 2) in which measurement-based dose information for a medication related to the physiological measurement is determined. The measurement-based dose information is then displayed on the storage device display 192.

The storage device 132 also includes a lock 322 and a biometric reader 326. The biometric reader 326 may be configured to receive a biometric reading from a user (e.g., the patient 102 of FIG. 1). The biometric reader 326 communicates the biometric reading to a processor (the processor of FIG. 1 or the processor 224 of FIG. 2). The processor verifies that the received biometric reading is that of an authorized user. In response to the received biometric reading being that of the authorized user, the lock 322 is unlocked.

When the lock 322 is unlocked, one or more of the bays 318 may be accessed. For example, doses in the bays 318 may be administered and/or doses can be loaded into the bays 318. An example of the biometric reader 326 may be a fingerprint analyzer.

In some embodiments, a passcode input may be used to verify an identity of a user. For example, a combination lock may be included in the storage device, the storage device display 192 may present a passcode and user identification icon, or another suitable user input may be presented to a user of the storage device 132.

The storage device 132 also includes a GPS receiver 324 (in FIGS. 3A and 3B “GPS 324”). The GPS receiver 324 may be configured to receive a positioning signal. The GPS receiver 324 communicates the positioning signal to a processor or module (the processor of FIG. 1, the processor 224 of FIG. 2, or the location module 210 of FIG. 2). The processor or module generates a location signal of the storage device 132 based on the positioning signal.

In addition, the storage device 132 includes lights 302 on one or more of the bays 318. The lights 302 may be configured to illuminate when a dose loaded into the corresponding bay 318 is due to be administered. For example, the light 302 of the Sunday bay 318A is illuminated on Sunday, when a dose of a medication loaded in the Sunday bay 318A is due to be administered.

In some embodiments, the bays 318 may include another component that indicates a dose loaded into the corresponding bay 318 is due to be administered. Alternatively, the component indicating a dose loaded into the corresponding bay 318 is due to be administered may be omitted.

With reference to FIG. 3B, the storage device 132 includes a bay access sensor 320. While only one bay access sensor 320 is depicted in FIG. 3B, the storage device 132 may include bay access sensors 320 on one or more of the bays 318. The bay access sensor 320 may be triggered by positioning the door 306 of the Sunday bay 318A in the open position. The bay access sensor 320 may generate a response signal, which may be communicated to a processor or module (the processor of FIG. 1, the processor 224 of FIG. 2, or the record module 206 of FIG. 2). The processor of the module may record a medication confirmation signal in response to reception of the response signal.

As discussed elsewhere herein, dose information, an alert, adherence data, a warning, or some combination thereof may be displayed on the storage device display 192. In FIG. 3A an example alert 330 is depicted. The alert 330 is displayed within a particular time interval of a scheduled time of a dose. The alert 330 may remind the patient to take a dose of a medication in accordance with the medication schedule. The alert 330 includes a text portion 312 that identifies the medication (First Medication), when the dose is due to be administered (Take Now), and the amount of the medication (1 Tablet). The alert also includes a graphical portion 310. The graphical portion 310 includes graphical depictions of a pill or anther medication to be administered that is included in the dose. The alert also includes a time portion 314. The time portion 314 includes the time (9:00 AM) the dose of the first medication is due to be administered. The dose information, e.g., the graphical portion 310 may correspond to the bay 318 in which the dose is contained. Additionally, the dose information, the alert, the adherence data, and the warning may correspond to the lights 302. For example, the light 302 of the Sunday bay 318A may illuminate indicating that the dose displayed in the display 134B is contained therein. A patient (e.g., the patient 102) may ensure she is taking the correct pill by comparing the pill contained in the Sunday bay 318A with the picture included in the graphical portion 310.

In FIG. 3B an example medication adherence message 332 is also depicted. The medication adherence message 332 includes the graphical portion 310 and the time portion 314 described above. The text portion 312 of the medication adherence message identifies the medication (First Medication) and indicates that the First Medication has been administered (Taken). In this and other embodiments, the medication adherence message is displayed in response to the response signal generated by the bay access sensor 320.

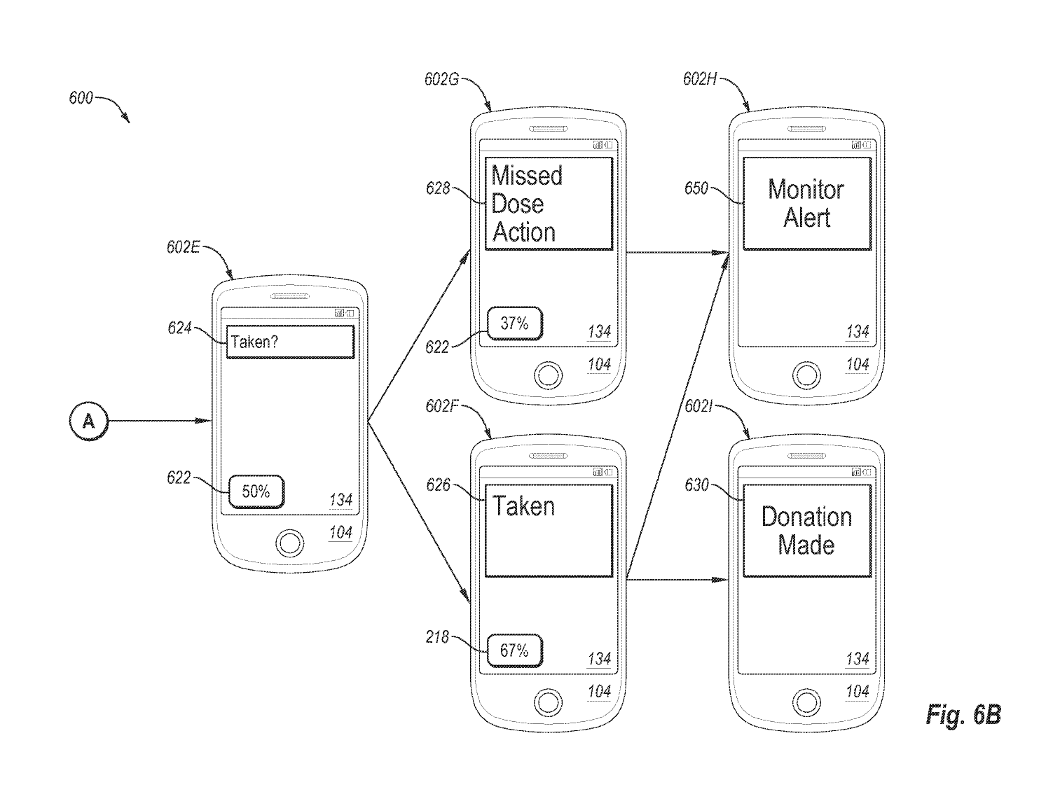

FIGS. 6A and 6B illustrate an example of the patient device 104 progressing through an example series of steps 602A-602I representative of a patient experience with the medication system 100 of FIG. 1. FIGS. 6A and 6B are described with FIGS. 3A and 3B to illustrate an example interrelationship between a storage device such as the storage device 132 of FIGS. 3A and 3B and the patient device 104 of FIGS. 6A and 6B. In the embodiment depicted in FIGS. 6A and 6B, the patient device 104 is a mobile device, such as a smartphone, although any other type of suitable programmable device may be used. In some embodiments, similar steps and/or a subset of the steps 602A-602I may occur in other types or classes of patient devices as described above.

In the example steps 602A-602I, the storage device 132 and the patient device 104 are associated with a patient. The storage device 132 and the patient device 104 may be paired and/or synchronized with one another and/or with one or more medication system components of FIG. 1. Accordingly, data including a medication schedule may be accurate and current at each of the patient device 104 and the storage device 132. As discussed above, the bays 318 of the storage device 132 may be loaded according to the medication schedule.

At each of the steps 602A-602I, display 134 of the patient device 104 is depicted to illustrate some example information that might be provided to the patient (e.g., the patient 102). With reference to FIG. 6A, a first step 602A displays a medication schedule 610 or a portion thereof. The medication schedule 610 may include one or more medications and/or the scheduled times at which a dose of the medication is to be taken. For example, in the illustrated medications schedule 610, a dose of a first medication is to be taken at 9:00 AM and a dose of a second medication is to be taken at 12:00 PM. In some embodiments, the medication schedule 610 may include other dose information such as a number of doses remaining, a figure or picture of the medication, a dose amount (e.g., one 400-milligram (mg) pill), and the like. The storage device display 192 may also display the medication schedule or the dose information. Alternatively, the storage device display 192 may display other dose information such as a next dose to be administered.

It may be appreciated with the benefit of this disclosure, that in the first step 602A only a portion of the medication schedule 610 is displayed. Specifically in the first step 602A, a day view may be displayed to the patient, which view may only constitute a portion of the medication schedule 610. In some embodiments, the medication schedule 610 displayed in the first step 602A may include a long-term calendar of one or more medications, doses of the one or more medications, scheduled times of the doses, additional information pertaining to the medications and/or doses, or any combination thereof. Accordingly, in some embodiments, in the first step 602A a week view, a multi-day view, a month view, etc. might be displayed.

A second step 602B is an example user interaction in which information is provided to a patient to assist in the selection of a charity (186 of FIG. 1). A ‘charity selection’ icon 612 may be presented to the patient, which may enable the patient to select or invite an appropriate charity. In some embodiments, the charity selection icon 612 represents a charity that is input by a patient. In other embodiments, the charity selection icon 612 may represent a charity selected by another entity or a request by a charity to be selected by the patient. A ‘save’ icon 614 may then enable the patient to save the charity included in the charity selection icon 612 as a charity that is to receive donations based on target levels. In embodiments in which the charity requests selection by the patient, rather than a save icon 614, an authorization or acceptance icon may be provided to the patient which may authorize or accept the request of the charity

A third step 602C is an example user interaction in which information is provided to the patient to assist in the selection of a monitor (e.g., the support entity 146 of FIG. 1). For example, a monitor selection icon 616 is presented to the patient, which enables the patient to select or invite an appropriate monitor. The monitor selection icon 616 may include contact information such as a telephone number, an email address, an internet protocol address of a device associated with the monitor, or similar selection criteria. A send icon 618 may then enable the patient to communicate the invitation to the selected monitor entity. In some embodiments, the monitor may instead communicate a request to the patient device 104 that includes appropriate contact information. In these and other embodiments, rather than a send icon 618, an authorization or acceptance icon might be provided, which can be used by the patient to authorize or accept the request of the monitor entity.

A fourth step 602D of the example user interaction includes information that may be displayed to the patient within a predetermined interval of a scheduled time to remind the patient to take a dose of a medication in accordance with the medication schedule. The predetermined interval “reminder” may be any appropriate time (for example, five minutes) and may be selected by a patient based on a personal preference or medical reason, for instance.

In the depicted embodiments, within the predetermined interval, an alert 620 may be displayed to the patient. The alert 620 can also be provided via an email message, a pushed message, a text message, a scheduled alarm from a local alert timer, or any other appropriate delivery mechanism. The alert 620 may be generated locally or may be communicated from another entity. Additionally, the alert 620 may be sent to two or more medication system components of FIG. 1. The alert 620 might include the medication scheduled to be taken and the scheduled time. For instance, in the illustrated example alert 620 indicates that the first medication is to be taken at 9:00 AM. In other embodiments, information such as a number of doses remaining, a figure or picture of the medication, a dose amount (e.g., one 400 mg pill), and/or any other relevant information might also be provided.

In this example, the adherence data is displayed in the form of medication adherence rate 622 represented by a percentage. While the medication adherence rate 622 is described in some detail with reference to FIGS. 6A and 6B any type of adherence data might be displayed in conjunction with the alert 620. For example, in this and other embodiments, one or more other types of adherence data (e.g. affliction-specific medication adherence rates, medication-specific medication adherence rates, healthcare adherence rate, differentiator adherence rates, or any combination thereof) may be displayed in this fourth step 602D, or any of the steps 602D-602I. Alternatively, the adherence data, for example the medication adherence rate 622, may not be displayed in the fourth step 602D.

The alert 620 coincides with the alert 330 displayed on the storage device display 192 and an illumination of the light 302 of the Sunday bay 318A in FIG. 3A. Thus, the patient can be exposed to the alerts 620 and 330 on multiple devices 104 and 132. The particular time interval may be any appropriate time (for example, five minutes) and may be selected by a patient based on a personal preference or medical reason, for instance.

In some embodiments, one of the alerts 620 and 330 may be generated locally (e.g., at the patient device 104 or the storage device 132) and communicated to the other patient device 104 or 132 via an email message, a pushed message, a text message, a scheduled alarm from a local alert timer, or any other appropriate delivery mechanism. Additionally or alternatively, the alerts 620 and 330 can be generated at one or more of the medication system components of FIG. 1 and communicated to the patient device 104 and the storage device 132.

With reference to FIG. 6B, in a fifth step 602E, an icon 624 is displayed to the patient. The icon 624 may enable generation of a response signal. The response signal may indicate that the patient took the dose of the medication displayed in the alert 620 of the fourth step 602D in accordance with the medication schedule 610 of the first step 602A. The icon 624 can be selected by the patient, which results in the generation of the response signal. In the fifth step 602E the adherence data might also be displayed in conjunction with the icon 624. The adherence data may indicate the patient's medication adherence rate 622, which may encourage the patient to take the scheduled dose of the medication. The icon 624 can be selected by the patient, which results in the generation of response signal. Additionally or alternatively, the response signal can be generated through triggering the bay access sensor 320. The response signal is then communicated to the storage device 132, the patient device 104, one or more of the medication system components, or some combination thereof.

A sixth step 602F represents an example display when the patient selected the icon 624 in the fifth step 602E, thereby indicating that the scheduled dose was administered. A ‘taken’ message 626 may be displayed to the patient. The ‘taken’ message 626 may be a manifestation of the response signal or may be triggered by the response signal.

Again, in the sixth step 602F, adherence data may be displayed in conjunction with the ‘taken’ message 626. The adherence data, here shown as medication adherence rate 622, may be calculated in substantially real-time based on the response signal. For example, the patient device 104 or a remote system may receive the response signal and calculate the medication adherence rate 622 in substantially real-time. In FIG. 6B, when the patient selects the icon 624 in the fifth step 602E, the medication adherence rate 622 updates, increasing the medication adherence rate to 67% from 50%.

A seventh step 602G represents information that may be displayed when the patient does not take the dose of the medication indicated by the alert 620. In this example, display of a message ‘Missed Dose Action’ 628 or similar is provided so as to indicate failure to administer a scheduled dose on the part of the patient. Such a message 628 might be provided immediately, or following a second predetermined interval after the scheduled dosage time. Again, adherence data might again be calculated in substantially real-time. For example, here the medication adherence rate 622 was calculated based on the failure to take the dose, which lowered the medication adherence rate from 50% to 37%. In some embodiments, a threshold for the adherence data may be set. When the adherence data does not meet a specified threshold, a communication or intervention with the patient may be triggered. For example, a minimum adherence rate threshold may be set at 38% in this embodiment. Accordingly, a healthcare provider or a support entity may communicate with the patient or intervene on behalf of the patient. Some example communications may be an email message reminding the patient to take the dose of the medication, or the system might alert the patient's healthcare provider to intervene.

In this and other embodiments, calculating the adherence data may not be limited to doses taken according to the medication schedule 610. The patient device 104 may enable generation of an unscheduled dose response signal. The unscheduled dose response signal may indicate a missed dose was taken apart from the medication schedule. In these and other embodiments, following a second predetermined interval after the scheduled time, a notification may be displayed to the patient. The notification may include an action to perform for a missed dose. The action may include simply taking the dose late, waiting until the next scheduled time, contacting a physician or pharmacist, or other appropriate action. When the action includes taking the dose of the medication late, an unscheduled dose response signal may be generated and communicated to the patient device 104 or a remote entity. The adherence data, such as the medication adherence rate 622, may again be calculated in substantially real-time based on the unscheduled dose response signal.

An eighth step 602H, represents an example user experience when a monitor alert icon 650 is presented to the patient. The monitor alert icon 650 may be presented when a patient does not take the dose of the medication included in the alert 620 or does not select the icon 624 that generates a corresponding response signal. In some embodiments, the eighth step 602H may occur following a second predetermined interval after the scheduled dosage time. The monitor alert icon 650 presented to the patient may indicate that a monitor alert has been generated and communicated to a monitor entity. The monitor alert icon 650 may further indicate that a monitor has been notified of circumstances triggering the monitor alert (e.g., a missed dosage event). The monitor alert icon may additionally include information indicating why the monitor alert is generated and communicated. For example, the monitor alert icon 650 may include a threshold that was exceeded by a failure to take a dose of a medication (for example, this is the third time a dosage event has been missed). Additionally, the monitor alert icon 650 may indicate one or more of: to whom the monitor alert is to be communicated; a history of monitor alerts; relevant medications pertaining to the monitor alert, and a relevant affliction pertaining to the monitor alert.

Additionally, the eighth step 602H may occur when a patient takes the dose of the medication indicated at the alert 620. For example, a monitor alert trigger may generate and communicate a monitor alert when a patient takes a critical medication. The monitor alert may indicate to the monitor that the critical medication was taken in compliance with a prescribed time. Thus, the monitor may respond with an encouraging remark or message, for example.

A ninth step 602I of the example user interaction may represent information displayed when a ‘donation’ icon 630 is presented to the patient. The donation icon 630 may be presented when patient achieves a target level by taking the dose of the medication included in the alert 620 and selects the icon 624 that generates a corresponding response signal. The donation icon 630 presented to the patient may indicate that a donation has been made. The donation icon 630 may further indicate the charity, a sponsor, a total donation amount, a ranking on a leader (or compliance) board, the target level reached, a “thank you,” and the like.

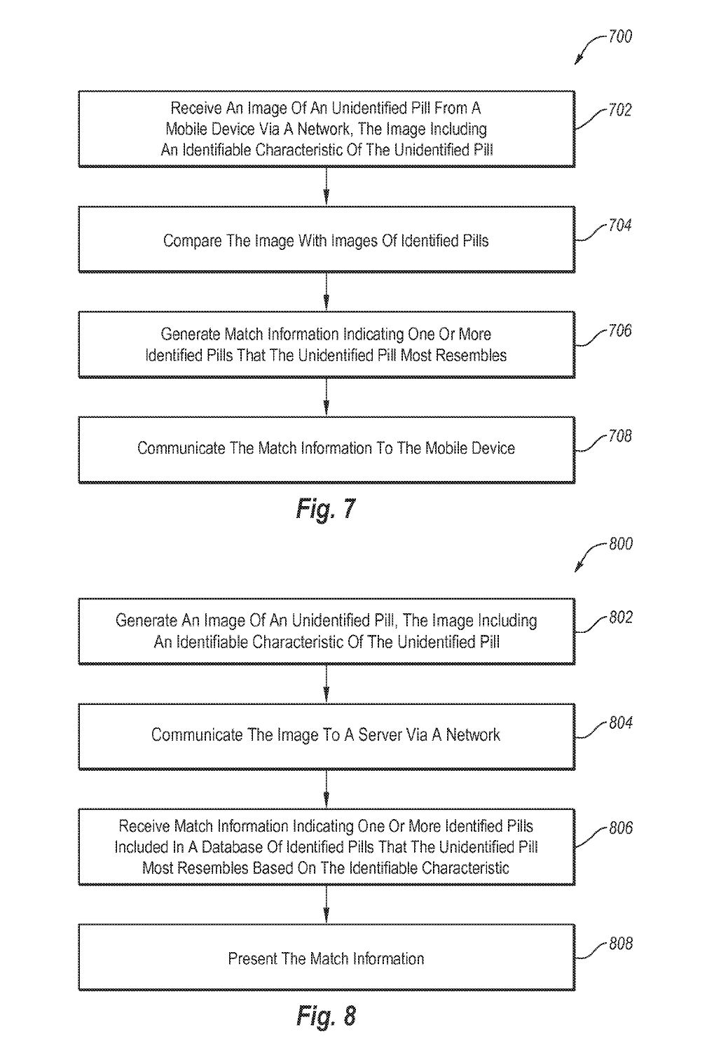

FIGS. 7-10B are flow diagrams of example methods 700, 800, 900, and 1000, arranged in accordance with at least one embodiment described herein. The methods 700, 800, 900, and 1000 may be performed in a medication system such as the medication system 100 of FIG. 1. The methods 700, 800, 900, and 1000 may be programmably performed in some embodiments by one or more of the medication system components described herein. For example, the patient device 104, the network server 112, the storage device 132, or some combination thereof may include or may be communicatively coupled to a non-transitory computer-readable medium (e.g., the memory 222 of FIG. 2) having stored thereon or encoded therein programming code or instructions that are executable by a processor to perform or cause performance of one or more of the methods 700, 800, 900, and 1000. Additionally or alternatively, the patient device 104, the network server 112, the storage device 132, or some combination thereof may include a processor (e.g., the processor 224 of FIG. 2) that is configured to execute computer instructions to cause or control performance of the one or more of the methods 700, 800, 900, and 1000. Although methods 700, 800, 900, and 1000 are illustrated in FIGS. 7-10B as discrete blocks, various blocks may be divided into additional blocks, combined into fewer blocks, or eliminated, depending on the desired implementation.

FIG. 7 is a flow diagram of an example method 700 of identifying pills. The method 700 may begin at block 702. At block 702, an image of an unidentified pill may be received from a mobile device via a network. The image may include one or more identifiable characteristics of the unidentified pill. The identifiable characteristic may include a shape, a height/width ratio, a geometry, a color, and an inscription, for example. The image may be included in a MMS message, an email message, or a message generated by a mobile device application (e.g., the pill ID module 152 of FIG. 1) configured to interface with a server.

At block 704, the image may be compared with images of identified pills. The images of the identified pills and the identifiable characteristics of the identified pills may be accessed from a database of identified pills. The database of identified pills includes images and identifiable characteristics of identified prescription medications, over-the-counter (OTC) medications, vitamins, illegal pills, and objects commonly mistaken as medication.

At 706, match information may be generated indicating one or more identified pills that the unidentified pill most resembles. At block 708, the match information may be communicated to the mobile device.

One skilled in the art will appreciate that, for this and other procedures and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the disclosed embodiments. For example, the method 700 may further include extracting the identifiable characteristic of the unidentified pill from the image. The identifiable characteristic of the unidentified pill may then be compared with identifiable characteristics of the images of the identified pills. The unidentified pill may be matched with one or more identified pills based on commonalities between the identifiable characteristic of the unidentified pill and the identifiable characteristics of the images of the identified pills.

Additionally, the method 700 may include obtaining additional information from an information database. The additional information may pertain to the one or more identified pill. The additional information may be communicated to the mobile device via the network.

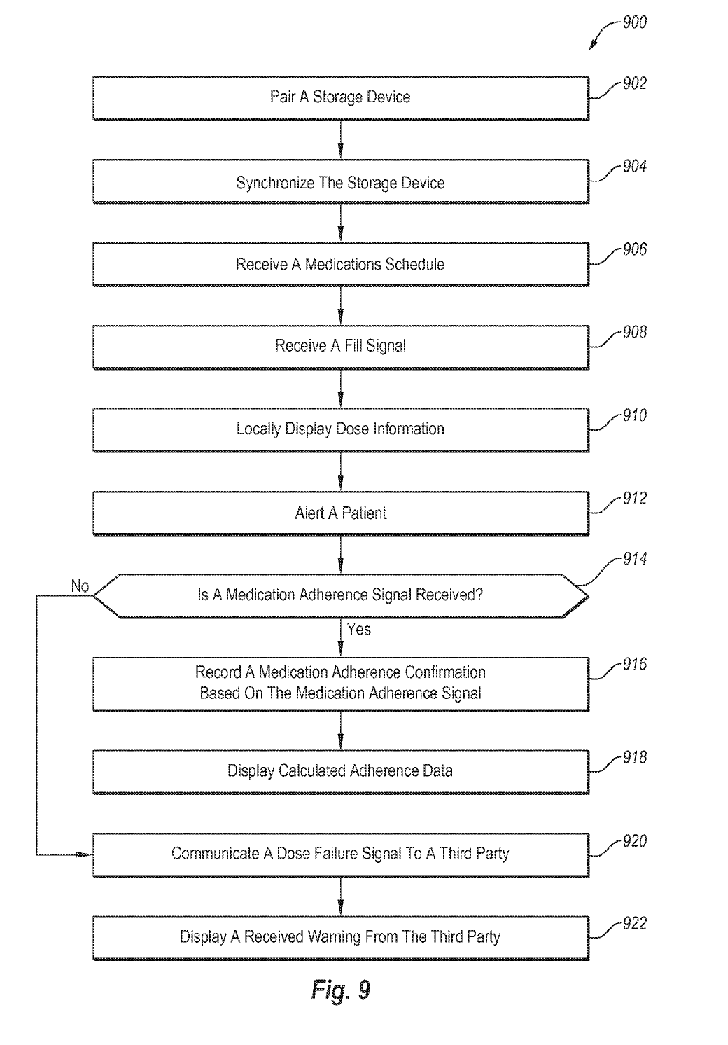

Additionally, when the match information indicates that the unidentified pill most resembles multiple identified pills, the method 700 may include communicating an instruction to resubmit the image with a particular identifiable characteristic visible. FIG. 8 is a flow diagram of another example method 800 of identifying pills. The method 800 may begin at block 802. At block 802, an image of an unidentified pill may be generated. The image may include one or more identifiable characteristic of the unidentified pill. The identifiable characteristic may include a shape, a geometry, a color, and an inscription on the unidentified pill, for instance. At block 804, the image may be communicated to a server via a network. The image may be communicated to the server in one or more of a MMS message, an email message, or a message configured as an interface with the server. Additionally or alternatively, one or more identifiable characteristics may be communicated to the server via the network with or without the image.

At block 806, match information may be received. The match information may indicate one or more identified pills from a database of identified pills that the unidentified pill most resembles. The identified pills may be matched to the image based on the identifiable characteristic. In some embodiments, the match information may be included in a MMS message, an email message, or the message configured to be received by a mobile device application. At block 808, the match information may be presented. For instance, the match information may be presented by displaying the match information on the display of a mobile device. Additionally or alternatively, the match information may be communicated via another user interface. For instance, the match information may be audio and be communicated via a speaker.

In some embodiments, the method 800 may include receiving additional information pertaining to the one or more identified pills. The additional information may indicate appropriate actions to take when encountering the one or more identified pill. The method 800 may also include presenting the additional information. In some embodiments, presenting the additional information may include displaying the additional information on a display of a mobile device. Additionally, the method 800 may include providing assistance to generate the image such that the identifiable characteristic is captured in the image. The assistance may include an overlay on a range finder and/or posing instructions.

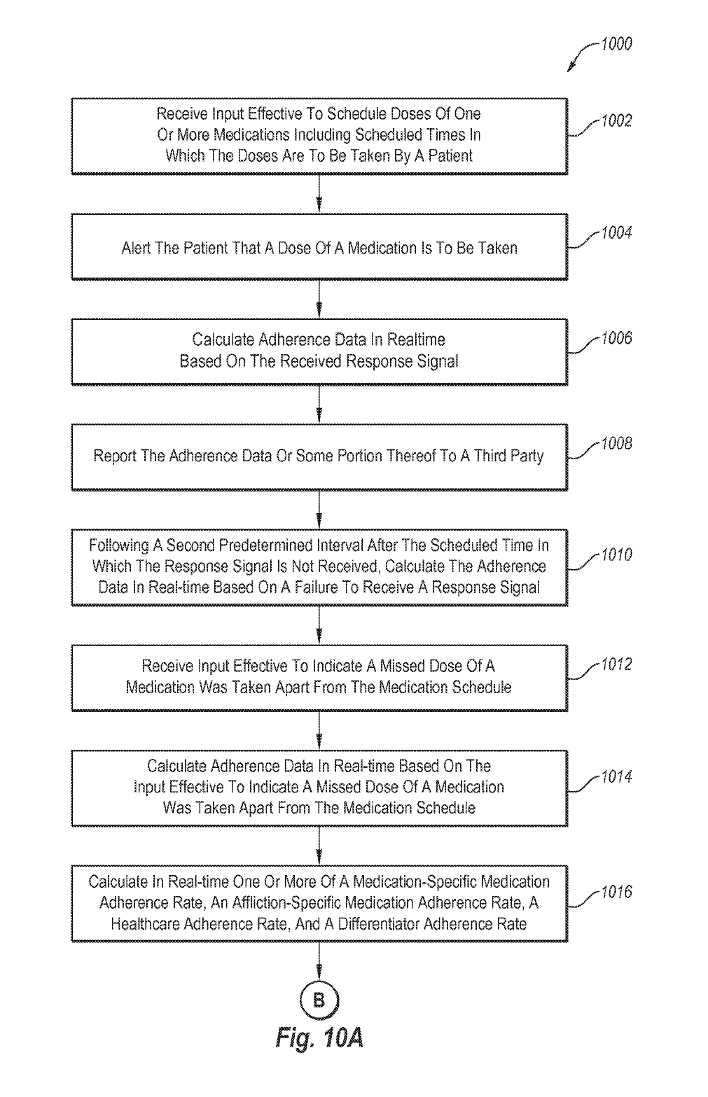

FIG. 9 is a flow diagram of an example method 900 of employing a medication storage device to facilitate medication compliance of a patient. The method 900 may begin at block 902. At block 902, a storage device may be paired. For example, the storage device may be paired with a patient adherence module of a patient device and/or a network adherence application.

At block 904, the storage device may be synchronized. For example, the storage device may be synchronized with a network adherence module and/or a patient adherence module of the patient device. The synchronizing may include receiving a medication schedule of a patient associated with the patient device. At block 906, a medication schedule may be received. At block 908, a fill signal may be received. For example, a fill sensor may be actuated by the patient to generate and communicate a fill signal.

At block 910, dose information may be locally displayed. For example, dose information may be displayed on the storage device display. The dose information may generally pertain to a dose of a medication and include an identity of a medication, a time in which the medication is to be administered, a graphical depiction of the dose of the medication, a QR code that links to some portion of the dose information, or some combination thereof. In some embodiments, the graphical depiction may be received from a network server.

At block 912, the patient may be alerted. The alert may include illuminating a light located on a bay of the medication storage device containing the dose. The alert may be received from another computing device in some embodiments or may be locally generated. The alert may be received or communicated to the patient within a particular time interval of a scheduled time of the dose. At block 914, it may be determined whether a response signal has been received. The response signal may indicate compliance with the dose information. In some embodiments, the response signal originates at a bay sensor of a bay of the medication storage device containing the dose. In response to the response signal being received (“Yes” at block 912), the method 900 may continue to block 916. In response to the response signal not being received (“No” at block 912), the method 900 may continue to block 920.

At block 916, a medication adherence confirmation may be recorded based on the response signal. At block 918, calculated adherence data may be displayed. The adherence data may be calculated based on the response signal. Additionally or alternatively, the response may be communicated to a network server or patient device or another computing device or server. For example, with reference to FIG. 1, the response may be communicated to one or more of the medication system components. At the computing device or server the adherence data may be calculated. The method 900 may accordingly include receiving the calculated adherence data, which is then displayed at block 918.

At block 920, a dose failure signal may be communicated to a third party. At block 922, a received warning from the third party may be displayed. The received warning may include a reminder to the patient to take the dose.

In some embodiments, it may be determined whether a location of a storage device is known. In response to the location of the storage device not being known, a location inquiry may be received. For example, with reference to FIG. 1, the storage device 132 may receive the location inquiry from the patient device 104 or the network adherence module 166. In response, a location signal may be transmitted from the storage device. The location signal may be based on locational information from a GPS receiver of the storage device and may include positioning information.

In embodiments, for instance in embodiments in which the storage device includes a lock, the method 900 may include receiving a biometric reading. The received biometric reading may be verified. For example, the received biometric reading may be verified as that of an authorized user or the patient. If the biometric reading is that of the authorized user or the patient the lock may be unlocked.

Additionally, it may be determined whether a prescription is exhausted. In response to the prescription being exhausted, the method 900 may include ordering a refill. In response to the prescription not being exhausted the method 900 may include updating a number of doses remaining.

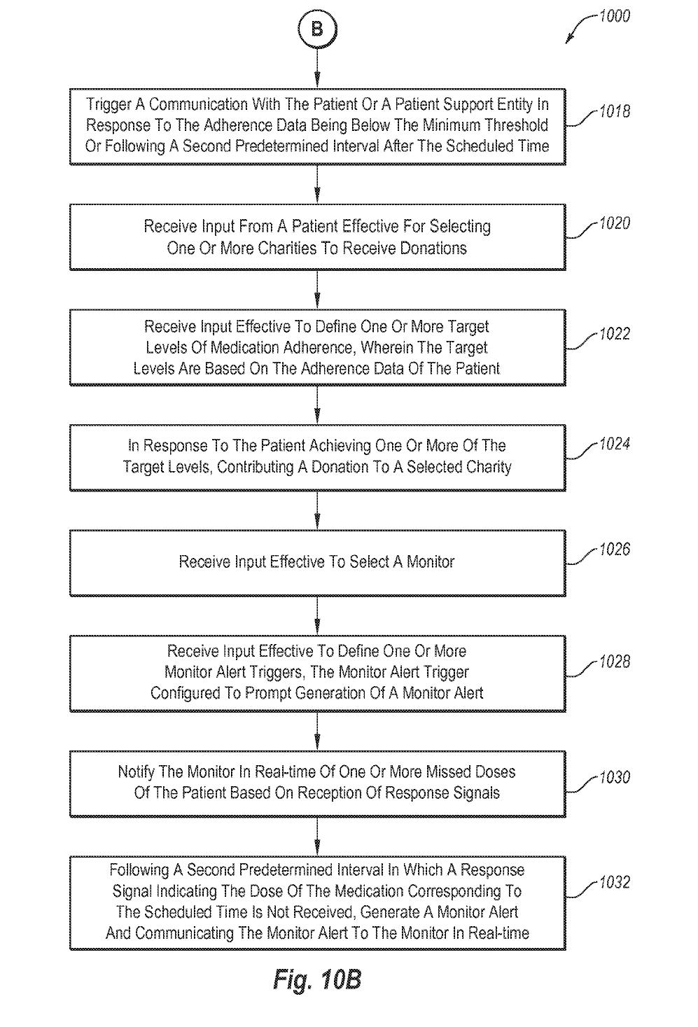

FIGS. 10A and 10B are a flow diagram of an example method 1000 of medication adherence measurement. With reference to FIG. 10A, the method 1000 may begin at block 1002. At block 1002, input effective to schedule doses of one or more medications may be received. The input may include scheduled times in which the doses are to be taken by a patient. The scheduled doses of the one or more medications may be included in a medications schedule. At block 1004, the patient may be alerted that a dose of a medication is to be taken. The patient may be alerted within a predetermined interval of a scheduled time. Alerting the patient may include one or more of pushing an alert, communicating a text message including the alert, interfacing with a local alert timer, and communicating an email message including the alert

At block 1006, adherence data may be calculated in real-time based on a received response signal. For example, the adherence data may be calculated in response to the received response signal indicating one of the doses is taken according to the medication schedule. At block 1008, the adherence data or some portion thereof may be reported to a third party.

At block 1010, the adherence data may be calculated in real-time based on a failure to receive a response signal. The adherence data may be calculated following a second predetermined interval after the scheduled time in which the response signal is not received. At block 1012, input effective to indicate a missed dose of a medication was taken apart from the medication schedule may be received. At block 1014, adherence data may be calculated in real-time based on the input effective to indicate a missed dose of a medication was taken apart from the medication schedule.

At block 1016, one or more of a medication-specific medication adherence rate, an affliction-specific medication adherence rate, a healthcare adherence rate, and a differentiator adherence rate may be calculated. The medication-specific medication adherence rate may be calculated for one or more medications based the response signal. The affliction-specific medication adherence rate may be calculated for one or more of the medications used to treat one or more comorbid afflictions. The healthcare adherence rate may be calculated for a healthcare activity including one or more of prescription refills, healthcare appointments, glucose testing, exercise, and blood pressure testing. The differentiator adherence rate may include medication adherence rates across a differentiator. The differentiator may further include one or more of a population segmented by geography, a population segmented by disease state, a population segmented by co-morbidity, a medication, a medication class, a treatment.

With reference to FIG. 10B, at block 1018, a communication with the patient or a support entity may be triggered. For example, the communication may be triggered in response to the adherence data being below the minimum threshold or following a second predetermined interval after the scheduled time. At block 1020, input may be received from a patient that is effective for selecting one or more charities to receive donations. The charity may include a recognized charity and/or an individual. At block 1022, input effective to define one or more target levels of medication adherence may be received. The target levels may be based on the adherence data of the patient. At block 1024, in response to the patient achieving one or more of the target levels, a donation may be contributed to a selected charity. The donations may be provided by a sponsor in some embodiments. Contributing the donation may include transferring a monetary donation or a prize incentive to the selected charity.

At block 1026, input effective to select of a monitor may be received. At block 1028, input may be received that is effective to define one or more monitor alert triggers. The monitor alert trigger may be configured to prompt generation of a monitor alert. The input may be received from a patient, the monitor, or a healthcare provider. At block 1030, a monitor alert may be generated and communicate to the monitor in real-time. The monitor alert may be generated and communicated following a second predetermined interval in which a response signal indicating the dose of the medication corresponding to the scheduled time is not received. The monitor alert triggers may include one or more of a threshold number of response signals are not received during a specified period of time, a threshold number of response signals are not received pertaining to a medication, a response signal of a current dose of a medication corresponding to the scheduled time is not received, a response signal of a current dose of a medication corresponding to the scheduled time is received, a mobile device of the patient is in a specific area, a response signal is not received for a critical medication adherence data is below a minimum threshold; and data related to healthcare adherence of a healthcare activity is below a minimum threshold.

As mentioned above, the embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may comprise non-transitory computer-readable storage media including RAM, ROM, EEPROM, CD-ROM or other optical disk storage, magnetic disk storage or other magnetic storage devices, or any other non-transitory storage medium which may be used to carry or store desired program code means in the form of computer-executable instructions or data structures and which may be accessed by a general purpose or special purpose computer. Combinations of the above should also be included within the scope of computer-readable media.

Computer-executable instructions may include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

1-17. (canceled)

18. A method of employing a medication storage device to facilitate medication compliance of a patient, the method comprising:
synchronizing a medication storage device with a network adherence module and a patient adherence module of a patient device, the synchronizing including receiving a medication schedule of a patient associated with the patient device;
receiving a fill signal indicating one or more medications are loaded in the medication storage device according to the medication schedule;
displaying dose information pertaining to a dose of a medication, wherein the dose information is at least partially included in the medication schedule;
within a predetermined time interval of a scheduled time of the dose, alerting the patient of the dose;
determining whether a response signal indicating compliance with the dose information is received; and
recording a medication confirmation signal in response to reception of the response signal.

19. The method of claim 18, further comprising pairing the medication storage device with the adherence module of the patient device.

20. The method of claim 18, further comprising:
in response to a determination that the response signal is not received, communicating a dose failure signal to a third party;
receiving a warning from the third party; and
displaying the warning on the medication storage device.

21. The method of claim 18, further comprising:
receiving a biometric reading from the patient;
verifying the received biometric reading is that of an authorized user; and
unlocking a lock of the medication storage device in response to the received biometric reading being that of the authorized user.

22. The method of claim 18, further comprising:
receiving a location inquiry; and
in response to the location inquiry, transmitting a location signal of the medication storage device based at least partially on a positioning signal to one or more of the network adherence applications or a patient device.

23. The method of claim 18, further comprising:
determining whether a prescription including the dose is exhausted;
in response to the prescription being exhausted, ordering a refill of the prescription; and
in response to the prescription not being exhausted, updating a number of doses remaining of the prescription.

24. The method of claim 18, further comprising:
receiving a physiological measurement of the patient;
based on the physiological measurement, determining measurement-based dose information for a medication related to the physiological measurement; and
displaying the measurement-based dose information.

25. The method of claim 18, further comprising displaying calculated medication adherence data, wherein the calculated medication adherence data is received from a network adherence module or locally calculated.

26. The method of claim 18, further comprising:
receiving an alert from a patient device, the alert including second dose information of a second dose of a second medication; and
in response to the received alert, displaying the second dose information on the medication storage device.

27. The method of claim 18, wherein:
the alerting includes illuminating a light located on a bay of the medication storage device containing the dose;
the response signal originates at a bay sensor of a bay of the medication storage device containing the dose; and
the dose information includes a graphical depiction of the dose.

28. A non-transitory computer-readable medium having encoded therein programming code executable by a processor to perform the method of claim 18.

29. A medication storage device comprising:
a display;
a processor; and
instructions stored in memory and executable by the processor to cause the processor to perform functions comprising:
synchronizing the medication storage device with a network adherence application, the synchronizing including receiving a medication schedule of a patient;
receiving a fill signal indicating one or more medications are loaded in the medication storage device according to the medication schedule;
locally displaying on the display dose information of a dose of a medication, the dose information being at least partially included in the medication schedule;
within a particular time interval of a scheduled time of the dose, alerting the patient of the dose;
determining whether a medication adherence signal indicating compliance with the dose information is received; and
recording a medication confirmation signal in response to reception of a medication adherence signal.

30. The medication storage device of claim 29, wherein the functions further comprise:
communicating a dose failure signal to a third party;
receiving a warning from the third party; and
displaying the warning on the medication storage device.

31. The medication storage device of claim 29, further comprising a biometric sensor and a lock communicatively coupled to the biometric sensor, wherein the functions further comprise:
receiving a biometric reading from the patient;
verifying the received biometric reading is that of an authorized user; and
unlocking the lock in response to the received biometric reading being that of the authorized user.

32. The medication storage device of claim 31, wherein the biometric sensor includes a fingerprint sensor.

33. The medication storage device of claim 29, further comprising a positioning receiver, wherein the functions further comprise:
receiving a location inquiry; and
in response to the location inquiry, transmitting a location signal of the medication storage device based at least partially on a positioning signal determined in the positioning receiver to one or more of the network adherence application or a patient device.

34. The medication storage device of claim 29, wherein the functions further comprise:
determining whether a prescription including the dose is exhausted; and
in response to the prescription being exhausted, ordering a refill of the prescription.

35. The medication storage device of claim 29, further comprising a physiological sensor, wherein the functions further comprise:
receiving a physiological measurement of the patient;
based on the physiological measurement, determining measurement-based dose information for a medication related to the physiological measurement; and
displaying the measurement-based dose information.

36. The medication storage device of claim 29, wherein the functions further comprise:
communicating the medication adherence confirmation to the network adherence application;
receiving calculated medication adherence data; and
displaying received medication adherence data on the display.

37. The medication storage device of claim 29, wherein the functions further comprise:
calculating medication adherence data based on the medication adherence confirmation; and
displaying calculated medication adherence data.

38. The medication storage device of claim 29, wherein the functions further comprise:
receiving an alert from a patient device, the alert including second dose information of a second dose of a second medication; and
in response to the received alert, displaying the second dose information on the medication storage device.

39. The medication storage device of claim 29, wherein the functions further comprise prior to synchronizing the medication storage device with the network adherence application, pairing the medication storage device with one or more of the medication adherence application and a patient device.

40. The medication storage device of claim 29, further comprising:
one or more bays including one or more lights; and
the operation of alerting includes illuminating a light located on a bay containing the dose.

41. The medication storage device of claim 29, further comprising:
one or more bays including one or more bay sensors; and
the medication adherence signal originates at a bay sensor of a bay containing the dose.

42. The medication storage device of claim 29, wherein the dose information includes a graphical depiction of the dose.

43. The medication storage device of claim 29, wherein the functions further comprise: contacting a healthcare provider in response to a user input.

44-88. (canceled)
